(19) United States
(12) Patent Application Publication
(10) Pub. No.: US 2026/0361684 A1
(43) Pub. Date: Nov. 12, 2026

(54) FIRST NODE, SECOND NODE, THIRD NODE, FOURTH NODE, FIFTH NODE AND METHODS PERFORMED THEREBY FOR HANDLING ONE OR MORE INTERNET PROTOCOL ADDRESSES

(71) Applicant: Telefonaktiebolaget LM Ericsson (publ), Stockholm (SE)

(72) Inventors: Victor GOMEZ-HIDALGO PEREZ, Toledo (ES); Carlota VILLASANTE MARCOS, Madrid (ES); Miguel Angel MUÑOZ DE LA TORRE ALONSO, Madrid (ES)

(21) Appl. No.: 19/515,649

(22) PCT Filed: Nov. 21, 2023
(86) PCT No.: PCT/EP2023/082562

§ 371 Date: Mar. 2, 2026

(30) Foreign Application Priority Data
Sep. 7, 2023 (EP) 23382913.4

(51) Int. Cl. H04L 61/5007

(52) U.S. Cl. CPC H04L 61/5007

(57) ABSTRACT

A computer-implemented method, performed by a first node The method is for handling one or more internet protocol addresses. The first node operates in a communications system. The first node determines first information indicating whether the one or more internet protocol addresses are, respectively, dedicated to a respective single application, or shared by a respective plurality of applications. The first node also provides the determined first information to a second node operating in the communications system.

### TECHNICAL FIELD

The present disclosure relates generally to a first node and methods performed thereby for handling one or more internet protocol addresses. The present disclosure also relates generally to a second node, and methods performed thereby for handling the one or more internet protocol addresses. The present disclosure further relates generally to a third node, and methods performed thereby for handling one or more internet protocol addresses. The present disclosure further relates generally to a fourth node and methods performed thereby for handling one or more internet protocol addresses. The present disclosure also relates generally to a fifth node, and methods performed thereby for handling the one or more internet protocol addresses.

### BACKGROUND

Computer systems in a communications network or communications system may comprise one or more nodes. A node may comprise a processing circuitry which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-Universal Terrestrial Radio Access (UTRA), as well as a Fifth Generation (5G) Packet Core Network, which may be referred to as 5G Core Network (5GC), abbreviated as 5GC.

FIG. 1 is a schematic diagram depicting a particular example of a 5G reference architecture of a policy and charging control framework, as defined by 3GPP, which may be used as a reference for the present disclosure. An Application Function (AF) 1 may provide a service in the communications system and may interact with the 3GPP Core Network through a Network Exposure Function (NEF) 2. The AF 1 may allow external parties to use the Exposure Application Programming Interfaces (APIs) offered by the network operator. In case the AF 1 is trusted, e.g., internal to the network operator, the AF 1 may interact with the 3GPP Core Network directly, with no NEF 2 involved. The NEF 2 may support different functionality. Specifically, the NEF 2 may support different Exposure APIs, e.g., NEF API for Packet Flow Description (PFD) Management. Management of Packet Flow Descriptions (PFDs) may be understood to refer to a capability to create, update or remove PFDs in the NEF (PFDF), and the distribution from the NEF 2, (PFDF), to a Session Management Function (SMF) 3 and finally to a User Plane function (UPF) 4. This feature may be used when the UPF 4 may be configured to detect a particular application provided by an Application Service Provider (ASP). PFDF may be understood as the NEF service for handling PFDs. A Unified Data Repository (UDR) 5 may store data grouped into distinct collections of subscription-related information: subscription data, policy data, structured data for exposure, and application data. A Charging Function (CHF) 6 may support charging related functionality, specifically online and offline charging. A Policy Control Function (PCF) 7 may support a unified policy framework to govern the network behavior. Specifically, the PCF 7 may provide Policy and Charging Control (PCC) rules to the Policy and Charging Enforcement Function (PCEF), that is, the SMF 3/UPF 4 that may enforce policy and charging decisions according to provisioned Policy and Charging Control (PCC) rules. The SMF 3 may support different functionalities, e.g., may receive PCC rules from the PCF 7 and may configure the UPF 4 accordingly. The UPF 4 may support handling of user plane traffic, including packet inspection, packet routing and forwarding, traffic usage reporting, Quality of Service (QOS) handling based on the rules received from the SMF 3. The UPF 4 may receive PFDs from the AF 1 through the NEF 2 and SMF 3. The SMF 3 may receive the PFD from the NEF 3 and may convert it to applications and filters in PDRs to be sent to the UPF 4. The PCF 7 may provide policy rules to a User Equipment (UE) through an Access and Mobility Function (AMF) 8. The AMF 8 may manage access of the UE. For example, when the UE may be connected through different access networks, and mobility aspects of the UE. A Network Data Analytics Function (NWDAF) 9 may be understood to represent an operator managed network analytics logical function. The NWDAF 9 may be part of the 5GC architecture and may use the mechanisms and interfaces specified for 5GC and Operations, Administration and Maintenance (OAM).

The NWDAF 9 may interact with different entities for different purposes. A first purpose may be data collection based on event subscription, provided by AMF 8, SMF 3, PCF 7, Unified Data Management (UDM), AF 1, directly or via NEF 2, and OAM; Another purpose may be retrieval of information from data repositories, e.g., UDR 5 via UDM for subscriber-related information; A further purpose may be retrieval of information about Network Functions (NFs), e.g., Network Repository Function (NRF) for Network Function (NF)-related information, and Network Slice Selection Function (NSSF) for slice-related information); Yet another purpose may be on demand provision of analytics to consumers. Another purpose may be storage in an Analytics Data Repository Function (ADRF) for two types of data: collected Data, e.g., Event Exposure data, and Analytics reports. Each of the UDR 5, the NEF 2, the NWDAF 9, the AF 1, the PCF 7, the CHF 6, the AMF 8, the SMF 3 and the UPF 4 may have an interface through which they may be accessed, which as depicted in the Figure, may be, respectively: Nudr 10, Nnef 11, Nnwdaf 12, Naf 13, Npcf 14, Nchf 15, Namf 16, Nsmf 17 and N4 18.

### REL18 PFD DETERMINATION ANALYTICS

In 3GPP Rel-18 23.288, Section 6.16 “PFD Determination analytics” [1], an analytic is described for PFD determination, which may allow the NWDAF to derive new/updated PFDs on a per application basis.

Existing methods to determine a packet flow may lead to derive PFDs may be understood to be based on statistical analysis of user plane traffic and do not provide enough accuracy.

### SUMMARY

As part of the development of embodiments herein, one or more challenges with the existing technology will first be identified and discussed.

According to existing methods, the analytic on “PFD Determination” described in [1], Section 6.16 “PFD Determination analytics”, may allow the NWDAF to derive new/updated PFDs for a certain application, by correlating user traffic both with existing PFDs and with the traffic matching a certain application, but it does not allow to discern if a certain server IP address is dedicated to a certain application or if instead it is shared by multiple applications.

Certain aspects of the present disclosure and their embodiments address one or more of the challenges identified with the existing methods and provide solutions to the challenges discussed.

Embodiments herein may provide a mechanism which may address the problems identified with the existing methods, which may be based on using analytics to discover the application/s hosted by a server.

More particularly, embodiments herein may provide a mechanism which may allow a network operator to automatically discover server IP addresses and how they may map into applications, based on Analytics, which may be provided, for example, by a NWDAF.

According to the foregoing, it is an object of embodiments herein to improve the handling of one or more internet protocol addresses via a communications system.

According to a first aspect of embodiments herein, the object is achieved by a computer-implemented method, performed by a first node. The method is handling one or more internet protocol addresses. The first node determines first information indicating whether the one or more internet protocol addresses are, respectively, dedicated to a respective single application, or shared by a respective plurality of applications. The first node then provides the determined first information to a second node operating in the communications system 100.

According to a second aspect of embodiments herein, the object is achieved by a computer-implemented method, performed by the second node. The method is for handling the one or more internet protocol addresses. The second node operates in the communications system. The second node receives the first information from the first node operating in the communications system. The first information indicates whether the one or more internet protocol addresses are, respectively, dedicated to a respective single application, or shared by a respective plurality of applications.

According to a third aspect of embodiments herein, the object is achieved by a computer-implemented method, performed by the third node. The third node is for handling the one or more internet protocol addresses. The third node operates in the communications system. The third node receives a second indication from the first node operating in the communications system, directly or indirectly via the second node operating in the communications system. The second indication requests stored information at the communications system indicating whether at least a first set of the one or more internet protocol addresses are, respectively, dedicated to a respective single first application or shared by a respective first plurality of applications. The third node then sends the requested stored information to the first node directly or indirectly via the second node.

According to a fourth aspect of embodiments herein, the object is achieved by a computer-implemented method, performed by a fourth node. The fourth node is for handling the one or more internet protocol addresses. The fourth operates in the communications system. The fourth node receives, directly or indirectly, a third indication from the first node operating in a communications system. The third indication requests notification of one or more events to occur in the communications system based on application traffic. The one or more events indicate whether at least a second set of the one or more internet protocol addresses are, respectively, dedicated to a respective single second application or shared by a respective second plurality of applications. The fourth node then sends the requested notification to the first node.

According to a fifth aspect of embodiments herein, the object is achieved by a computer-implemented method, performed by a fifth node. The fifth node is for handling the one or more internet protocol addresses. The fifth node operates in the communications system. The fifth node receives a fourth indication from the first node operating in the communications system. The fourth indication requests whether one or more internet protocol addresses in a fourth set of the one or more internet protocol addresses for which it is unknown whether the one or more internet protocol addresses in the fourth set are, respectively, dedicated to a respective application or shared by a respective plurality of applications are, respectively, dedicated to a respective single application or shared by a respective plurality of applications .. The fifth node then determines sends, responsive to the received fourth indication, a fifth indication to the first node. The fifth indication indicates whether the one or more internet protocol addresses in the fourth set are, respectively, dedicated to a respective single application or shared by a respective plurality of applications.

According to a sixth aspect of embodiments herein, the object is achieved by the first node, for handling the one or more internet protocol addresses. The first node is configured to operate in the communications system. The first node is configured to determine the first information configured to indicate whether the one or more internet protocol addresses are, respectively, configured to be dedicated to a respective single application, or shared by a respective plurality of applications. The first node is also configured to provide the determined first information to the second node configured to operate in the communications system.

According to a seventh aspect of embodiments herein, the object is achieved by the second node, for handling the one or more internet protocol addresses. The second node is configured to operate in the communications system. The second node is configured to receive the first information from the first node configured to operate in the communications system. The first information is configured to indicate whether the one or more internet protocol addresses are, respectively, configured to be dedicated to a respective single application, or shared by a respective plurality of applications.

According to an eighth aspect of embodiments herein, the object is achieved by the third node, for handling the one or more internet protocol addresses. The third node is configured to operate in the communications system. The third node is configured to receive the second indication from the first node configured to operate in the communications system, directly or indirectly via the second node configured to operate in the communications system. The second indication is configured to request the stored information at the communications system configured to indicate whether at least the first set of the one or more internet protocol addresses are, respectively, configured to be dedicated to a respective single first application or shared by a respective first plurality of applications. The third node is also configured to send the stored information configured to be requested to the first node directly or indirectly via the second node.

According to a ninth aspect of embodiments herein, the object is achieved by the fourth node, for handling the one or more internet protocol addresses. The fourth node is configured to operate in the communications system. The fourth node is configured to receive, directly or indirectly, the third indication from the first node configured to operate in the communications system. The third indication is configured to request the notification of the one or more events to occur in the communications system based on the application traffic. The one or more events are configured to indicate whether at least the second set of the one or more internet protocol addresses are, respectively, configured to be dedicated to a respective single second application or shared by a respective second plurality of applications. The fourth node is also configured to send the notification configured to be requested to the first node.

According to a tenth aspect of embodiments herein, the object is achieved by the fifth node, for handling the one or more internet protocol addresses. The fifth node is configured to operate in the communications system. The fifth node is configured to receive the fourth indication from the first node configured to operate in the communications system. The fourth indication is configured to request whether the one or more internet protocol addresses in the fourth set of the one or more internet protocol addresses for which it is unknown whether the one or more internet protocol addresses in the fourth set are, respectively, configured to be dedicated to a respective application or shared by a respective plurality of applications are, respectively, configured to be dedicated to a respective single application or shared by a respective plurality of applications. The fifth node is also configured to send, responsive to the fourth indication configured to be received, the fifth indication to the first node. The fifth indication is configured to indicate whether the one or more internet protocol addresses in the fourth set are, respectively, configured to be dedicated to a respective single application or shared by a respective plurality of applications.

By determining the first information indicating whether the one or more internet protocol addresses are, respectively, dedicated to a respective single application, or shared by a respective plurality of applications, the first node may then be enabled to provide the determined first information to the second node operating in the communications system.

By receiving the first information, a network operator of the communications system managing the second node 112 may thereby be enabled to discover server IP addresses and how they may map into applications in a simple, automatic, and efficient way. The mobile network operator may thereby be enabled to improve the accuracy of traffic classification, even in a context of fully encrypted traffic, since misclassification of traffic may be understood to imply applying wrong traffic management actions, such as e.g., QoS.

By receiving the second indication from the first node, the third node may be then enabled to send the requested stored information to the first node. This may in turn enable the first node to retrieve any previously stored information indicating whether some of the one or more internet protocol addresses are, respectively, dedicated to a respective single first application or shared by a respective first plurality of applications. The first node may thereby be enabled to achieve the technical advantages already described above.

By receiving the third indication from the first node, the fourth node may be then enabled to send the requested notification to the first node. This may in turn enable the first node to be notified of any events indicating whether some other of the one or more internet protocol addresses are, respectively, dedicated to a respective single first application or shared by a respective first plurality of applications. The first node may thereby be enabled to achieve the technical advantages already described above.

By receiving the fourth indication from the first node, the fifth node may be enabled to send the fifth indication to the first node. This may in turn enable the first node to find out whether any of the one or more internet protocol addresses for which it may be unknown whether they may be dedicated to a respective application or shared by a respective plurality of applications, they may be indeed, respectively, dedicated to a respective single application or shared by a respective plurality of applications. The first node may thereby be enabled to achieve the technical advantages already described above.

### BRIEF DESCRIPTION OF THE DRAWINGS

Examples of embodiments herein are described in more detail with reference to the accompanying drawings, according to the following description.

FIG. 1 is a schematic diagram illustrating an example of a 5G Network Architecture, according to existing methods.

FIG. 2 is a schematic diagram illustrating a non-limiting example of a communications system, according to embodiments herein.

FIG. 3 is a flowchart depicting embodiments of a method in a first node, according to embodiments herein.

FIG. 4 is a flowchart depicting embodiments of a method in a second node, according to embodiments herein.

FIG. 5 is a flowchart depicting embodiments of a method in a third node, according to embodiments herein.

FIG. 6 is a flowchart depicting embodiments of a method in a fourth node, according to

FIG. 7 is a flowchart depicting embodiments of a method in a fifth node, according to embodiments herein.

FIG. 8 is a schematic diagram depicting a non-limiting example of signalling between nodes in a communications system, according to embodiments herein.

FIG. 9 is a schematic block diagram illustrating two non-limiting examples, a) and b), of a first node, according to embodiments herein.

FIG. 10 is a schematic block diagram illustrating two non-limiting examples, a) and b), of a second node, according to embodiments herein.

FIG. 11 is a schematic block diagram illustrating two non-limiting examples, a) and b), of a third node, according to embodiments herein.

FIG. 12 is a schematic block diagram illustrating two non-limiting examples, a) and b), of a fourth node, according to embodiments herein.

FIG. 13 is a schematic block diagram illustrating two non-limiting examples, a) and b), of a fifth node, according to embodiments herein.

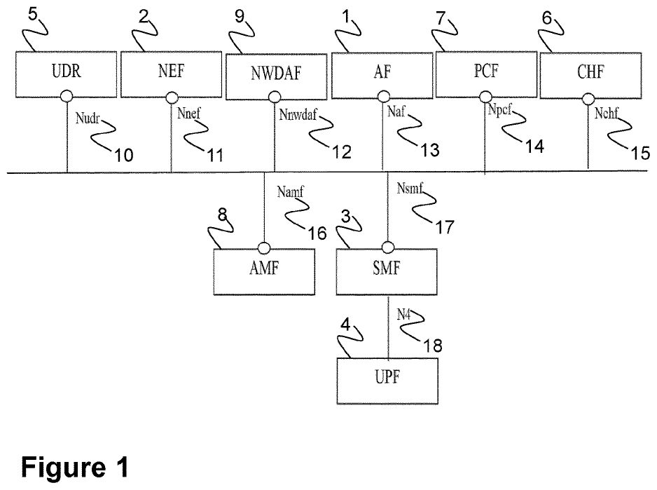

### DETAILED DESCRIPTION

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

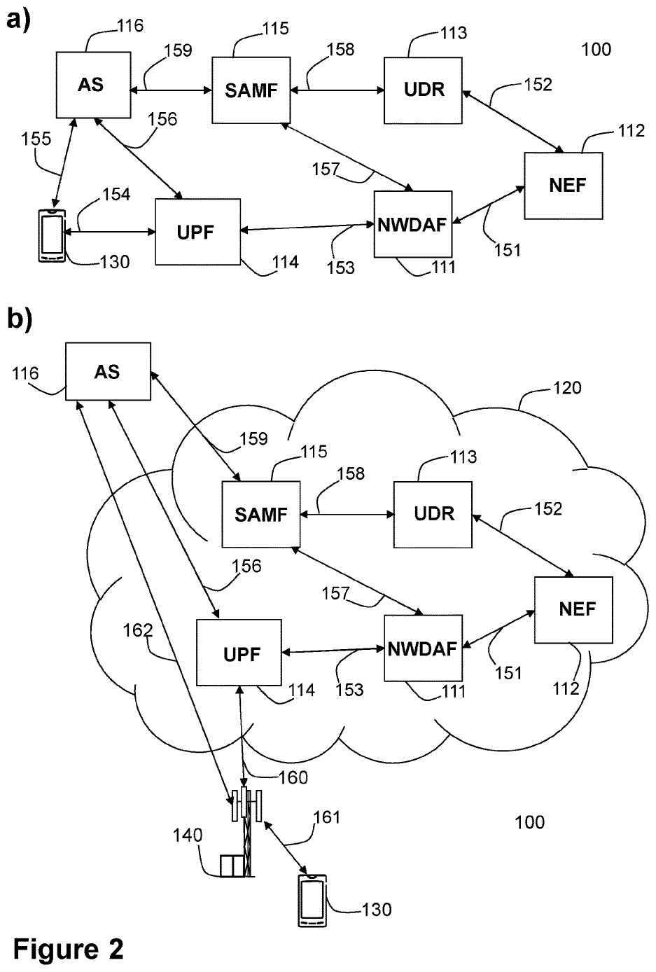

FIG. 2 depicts two non-limiting examples, in panels “a” and “b”, respectively, of a communications system 100, in which embodiments herein may be implemented. In some example implementations, such as that depicted in the non-limiting example of FIG. 2a, the communications system 100 may be a computer network. In other example implementations, such as that depicted in the non-limiting example of FIG. 2b, the communications system 100 may be implemented in a telecommunications system, sometimes also referred to as a telecommunications network, cellular radio system, cellular network, or wireless communications system. In some examples, the telecommunications system may comprise network nodes which may serve receiving nodes, such as wireless devices. The communications system 100 may for example be a network such as a 5G system, or a newer system supporting similar functionality. In some examples, the communications system 100 may further support other technologies, such as, for example a Long-Term Evolution (LTE), e.g., LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Mobile Telecommunications System Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising any combination of Radio Access Technologies (RATs) such as e.g. Multi-Standard Radio (MSR) base stations, multi-RAT base stations etc., any 2rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first node 111, a second node 112, a third node 113, a fourth node 114, a fifth node 115, and a sixth node 116 are depicted in FIG. 2. It may be understood that the communications system 100 may comprise more nodes than those represented on FIG. 2. The first node 111, the second node 112, the third node 113, the fourth node 114 and the fifth node 115 may be comprised in, or be internal to, the communications system 100. The fourth node 114 may be external to the communications system 100 but may operate via the communications system 100.

Any of the third node 113, the fourth node 114 and the fifth node 115 may be referred to as one or more other nodes 113, 114, 115.

Any of the first node 111, the second node 112, the third node 113, the fourth node 114, the fifth node 115 and the sixth node 116 may be understood, respectively, as a first computer system, a second computer system, a third computer system, a fourth computer system, a fifth computer system and a sixth computer system. In some examples, any of the first node 111, the second node 112, the third node 113, the fourth node 114, the fifth node 115 and the sixth node 116 may be implemented as a standalone server in e.g., a host computer in the cloud 120, as depicted in the non-limiting example depicted in panel b) of FIG. 2. Any of the first node 111, the second node 112, the third node 113, the fourth node 114, the fifth node 115 and the sixth node 116 may in some examples be a distributed node or distributed server, with some of their respective functions being implemented locally, e.g., by a client manager, and some of their functions implemented in the cloud 120, by e.g., a server manager. Yet in other examples, any of the first node 111, the second node 112, the third node 113, the fourth node 114, the fifth node 115 and the sixth node 116 may also be implemented as processing resources in a server farm.

Any of the first node 111, the second node 112, the third node 113, the fourth node 114, and the fifth node 115 may be co-localized.

The first node 111 be understood as a an operator managed network analytics logical function. That is, as a node that may have a capability to handle data collection and analysis from different sources in the communications system 100. The first node 111 may have to collect data based on event subscription, directly or via the second node 112, retrieve information from data repositories, e.g., from the third node 113 for subscriber-related information, retrieve information about NFs, provide analytics to consumers on demand, store in an analytics function, e.g., ADRF, for two types of data: collected Data, and Analytics reports. As depicted in FIG. 2, a non-limiting example of the first node 111, wherein the communications system 100 may be a 5G network, may be an NWDAF.

The second node 112 be a node that may have a capability to support different functionality, e.g., different Exposure APIs, such as an API for PFD Management. As depicted in FIG. 2, a particular non-limiting example of the second node 112, wherein the communications system 100 may be a 5G network, may be a NEF.

The third node 113 may be a node having a capability to store data, e.g., grouped into distinct collections of subscription-related information: subscription data, policy data, structured data for exposure, and application data. As depicted in FIG. 2, a particular non-limiting example of the third node 113, wherein the communications system 100 may be a 5G network, may be a UDR.

The fourth node 114 may be a node having a capability to support handling of user plane traffic, including packet inspection, packet routing and forwarding, traffic usage reporting, Quality of Service (QOS) handling, e.g., based on rules. The fourth node 114 may receive PFDs through, e.g., the second node 112. As depicted in FIG. 2, a non-limiting example of the fourth node 114, wherein the communications system 100 may be a 5G network, may be a UPF.

The fifth node 115 may a capability to map a server to an application, according to embodiments herein. The fifth node 115 may be understood as a new network function, used to retrieve the mapping between servers and the hosted application/s. As depicted in FIG. 2, as non-limiting example, the fifth node 115 may be referred to herein, wherein the communications system 100 may be a 5G network, as a Server to Application Mapping Function (SAMF). This may be a user plane related service function, either a Service Function (SF) co-located with the fourth node 114, e.g., a UPF, or external to the UPF, e.g., in the 5G Local Area Network (LAN).

The sixth node 116 may be a node having a capability to manage service of an application to a device, such as any of the one or more devices 130 described below. The sixth node 116 may interact with the core network of the communications system 100 through the fourth node 114 and/or the fifth node 115. As depicted in FIG. 2, a particular non-limiting example of the sixth node 116, wherein the communications system 100 may be a 5G network, may be an AS. In some embodiments herein, the sixth node 116 may be also referred to herein as a respective server 116.

The communications system 100 may also comprise one or more devices 130. Any of the one or more devices 130 may be also known as e.g., user equipment (UE), a wireless device, mobile terminal, wireless terminal and/or mobile station, mobile telephone, cellular telephone, or laptop with wireless capability, an Internet of Things (IoT) device, or a Customer Premises Equipment (CPE), just to mention some further examples. Any of the one or more devices 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, an Internet of Things (IoT) device, e.g., a sensor or a camera, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. Any of the one or more devices 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a radio network node 140 is depicted in FIG. 2b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The second node 112 may communicate with the third node 114 over a second link 152, e.g., a radio link or a wired link. The first node 111 may communicate with the fourth node 114 over a third link 153, e.g., a radio link or a wired link. The fourth node 114 may communicate, e.g., directly or indirectly, with the one or more devices 130 over a respective fourth link 154, e.g., a radio link or a wired link. The sixth node 116 may communicate with the one or more devices 130, e.g., directly or indirectly, over a respective fifth link 155, e.g., a radio link or a wired link. The sixth node 116 may communicate with the fourth node 114 over a sixth link 156, e.g., a radio link or a wired link. The fifth node 115 may communicate with the first node 111 over a seventh link 157, e.g., a radio link or a wired link. The fifth node 115 may communicate with the third node 113 over an eighth link 158, e.g., a radio link or a wired link. The fifth node 115 may communicate with the sixth node 116 over a ninth link 159, e.g., a radio link or a wired link. The fourth node 114 may communicate with the radio network node 140 over a tenth link 160, e.g., a radio link or a wired link. The radio network node 140 may communicate with the one or more devices 130 over a respective eleventh link 161, e.g., a radio link or a wired link. The sixth node 116 may communicate with the radio network node 140 over a twelfth link 162, e.g., a radio link or a wired link.

Any of the first link 151, the second link 152, the third link 153, the fourth link 154, the fifth link 155, the sixth link 156, the seventh link 157, the eighth link 158, the ninth link 159, the tenth link 160, the eleventh link 161 and/or the twelfth link 162 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 2.

Although terminology from Long Term Evolution (LTE)/5G has been used in this disclosure to exemplify the embodiments herein, this should not be seen as limiting the scope of the embodiments herein to only the aforementioned system. Other wireless systems supporting similar or equivalent functionality may also benefit from exploiting the ideas covered within this disclosure.

In some embodiments wherein the communications system 100 may be a 5G system, the first node 111 may be an NWDAF, the second node 112 may be a NEF, the third node 113 may be a UDR, the fourth node 114 may be a UPF, the fifth node 115 may be a SAMF and the sixth node 116 may be an AS.

In some embodiments wherein the communications system 100 may be a 5G system, the first node 111 may be a NWDAF, the second node 112 may be a NEF, the one or more other nodes 113, 114, 115 may comprise at least one of: the third node 113, the third node 113 being a UDR, the fourth node 114, the fourth node 114 being a UPF, and the fifth node 115, the fifth node 115 being a SAMF.

In future telecommunication networks, e.g., in the sixth generation (6G), the terms used herein may need to be reinterpreted in view of possible terminology changes in future technologies. In general, the usage of “first”, “second”, “third”, “fourth”, “fifth”, “sixth”, “seventh”, “eighth”, “ninth”, “tenth”, “eleventh” and/or “twelfth” herein may be understood to be an arbitrary way to denote different elements or entities and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

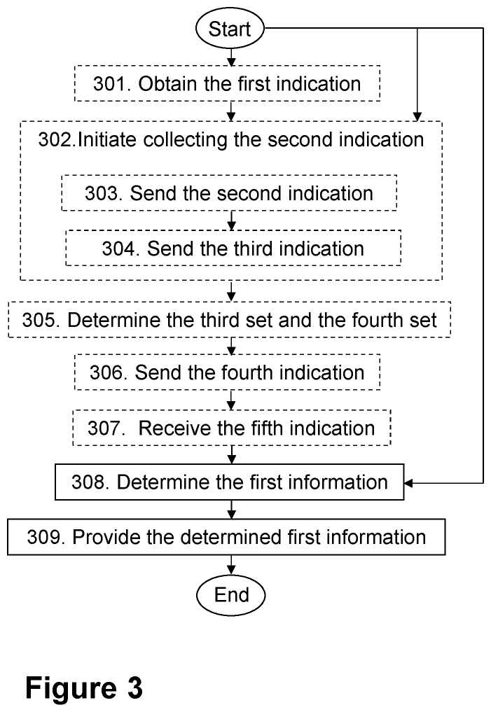

Embodiments of a computer-implemented method, performed by the first node 111, will now be described with reference to the flowchart depicted in FIG. 3. The method may be understood to be for handling one or more internet protocol addresses. The first node 111 operates in the communications system 100.

Several embodiments are comprised herein. In some embodiments, all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 3.

In FIG. 3, optional actions are represented with dashed lines.

### Action 301

In this Action 301, the first node 111 may obtain a first indication, directly or indirectly, from the second node 112. The second node 112 may be a consumer, e.g., NEF.

The first indication requests first information. The first information indicates whether one or more internet protocol addresses are, respectively, dedicated to a respective single application, or shared by a respective plurality of applications. The second node 112 may want to know whether the one or more internet protocol addresses may, respectively, dedicated or shared, since the second node 112 may want to avoid misclassification of traffic. When a server IP address is shared by a plurality of applications, the second node 112 may want to refrain from using that IP address, as PFD, for classification into a certain application, e.g., App-ID, due to potential misclassification. Only server IP addresses which may be determined to be dedicated may be used to avoid misclassification.

Obtaining may comprise receiving, e.g., via the first link 151.

In some examples, the first indication may indicate a request to subscribe to the first node 111 on an analytic. In some examples, this analytic may be new analytic on IP address to application mapping. Alternatively, the existing PFD Determination analytic, e.g., in 3GPP TS 23.288, v. 18.2.0, may be updated or extended, according to embodiments herein, to derive new/updated PFDs of type Server IP address, in this case by ensuring the Server IP address/es host a single application.

The first indication may be, in such examples, and wherein the first node 111 may be an NWDAF, a Nnwdaf_AnalyticsSubscription_Subscribe request message.

In some embodiments, the first indication may comprise at least one of the following parameters. According to a first option, the first indication may comprise a first identifier of an analytic indicating request of the first information. More particularly, the analytic may indicate the first information. For example, the first identifier may be Analytic-ID=IPtoAppMapping.

According to a second option, the first indication may comprise a second identifier of the one or more devices 130 for which the first information may be being requested. In other words, the second identifier may indicate the one or more devices 130, e.g., UE(s) which may be the target for this new analytic. For example, the second identifier may be AnyUE.

According to a third option, the first indication may comprise a third identifier of one or more applications for which the first information may be being requested. In other words, the second identifier may indicate the application(s) which may be the target for this new analytic. For example, the third identifier may be Any App-ID.

According to a fourth option, the first indication may comprise one or more filters to be applied to the first information to be provided in response to the first indication. For example, the one or more filters may be an Analytic-Filter parameter. The one or more filters may comprise a Data Network Name (DNN), and Serving Network Slice Selection Assistance Information (S-NSSAI). The DNN may be understood to indicate that the first information may be requested for a specific data network, e.g., Mobile Broadband. The S-NSSAI may be understood to indicate that the first information may be requested for a specific network slice, e.g., Enterprise slice.

The first node 111 may answer the first indication with a successful response accepting the request.

### Action 302

The first node 111 may perform an analysis of other information, e.g., data, in order to ultimately yield the first information in return to the received first indication. The data or information the first node 111 may analyze in order to obtain the first information may be referred to herein as second information. In this Action 302, the first node 111 may initiate collecting second information indicating the first information from one or more other nodes 113, 114, 115 operating in a communications system 100.

Initiating may be understood as triggering, starting, facilitating or enabling.

In some embodiments, it may be that the second information may have already been determined and stored in the communications system 100 in e.g., a node with a capability to store such information, as for example, the third node 113. This may be the case for a first set of the one or more internet protocol addresses.

In some embodiments, for a second set of the one or more internet protocol addresses, the second information may not be available, and it may need to be gathered from application traffic, as the application traffic may be generated.

In accordance with this, in some embodiments, the initiating in this Action 302 of the collection of the second information may comprise at least one of Action 303 and Action 304. In Action 303, the second information corresponding to the first set of one or more internet protocol addresses may be retrieved. In Action 304, the second information corresponding to the second set of one or more internet protocol addresses may be gathered.

### Action 303

In some embodiments, the second information collected by the first node 111 may be derived from PFDs. Particularly, the first node 111 may initiate collecting the second information in Action 302 to retrieve PFDs of Type Server IP address on a per application basis. The retrieval of the PFDs may be for all the applications the second node 112 may have requested the first information for in the first indication. The retrieval may be performed from 3-tuples. The 3-tuples may consist of three parameters in an IP packet: server IP address, server port and IP protocol. Neither domain names nor Uniform Resource Locators (URLs) may need to be retrieved. This may be understood to advantageously mean less signaling. That is, instead of retrieving all the PFDs, 3-tuples, domain names and URLs, only 3-tuples may need to be retrieved.

In some embodiments, in this Action 303, the first node 111 may send, directly or indirectly, a second indication to the third node 113 operating in the communications system 100 The second indication may request stored information at the communications system 100. The stored information may indicate whether at least the first set of the one or more internet protocol addresses may be, respectively, dedicated to a respective single first application or shared by a respective first plurality of applications.

The second indication may comprise the third identifier, e.g., Any App-ID, and a first additional indication to retrieve (server) IP only information, such as, for example, “IP only”. As stated earlier, neither domain names nor URLs may need to be retrieved.

In some examples, the first node 111 may send the second indication to the third node 113 indirectly via the second node 112. In such examples, the sending of the second indication in this Action 303 may comprise triggering data collection from the second node 112. The second indication in such examples wherein the second node 112 may be a NEF, may be, e.g., a Nnef_PFDManagement_Fetch request message.

In examples wherein the first node 111 may perform Action 303, the first node 111 may then collect the second information by receiving the stored information. The stored information may be received in a response message from the third node 113, indirectly via the second node 112. The stored information may indicate whether the first set of the one or more internet protocol addresses may be, respectively, dedicated to a respective single first application or shared by a respective first plurality of applications.

In some embodiments, the second information collected by the first node 111 may comprise a list of identifiers of applications and PFDs of Type Server IP received by the first node 111 from the third node 113 via the second node 112. That is, a list of identifiers of the stored applications, e.g., as an App-ID out of the applications indicated by the third identifier, and their corresponding IP PFDs. In a non-limiting example, this may be including the PFDs of type IP for any App-ID.

### Action 304

In some embodiments, in this Action 304, the first node 111 may send, directly or indirectly, a third indication to the fourth node 114 operating in the communications system 100. The third indication may request notification of one or more events to occur in the communications system 100, based on application traffic. The one or more events may indicate whether at least the second set of the one or more internet protocol addresses may be, respectively, dedicated to a respective single second application or shared by a respective second plurality of applications.

In some examples, the first node 111 may send the third indication to the fourth node 114 indirectly, via a seventh node 117 comprised in the communications system 100. For example, in embodiments wherein the first node 111 may be an NWDAF, and the fourth node 114 may be a UPF, the NWDAF may trigger data collection from the UPF, e.g., via the SMF. In some of such examples, the third indication may be, e.g., an Nsmf_EventExposure_Subscribe request.

The third indication may comprise a fourth identifier of the one or more events it may request notification of. In an example, the fourth identifier may be, e.g., Event-ID=UserDataUsageMeasures.

In some examples, the third indication may further comprise a further indication to report traffic matching the catch-all rule.

The third indication may further comprise a first parameter indicating a type of measurement to be reported. For example, the first parameter may be a Measurement Type=“APPLICATION_RELATED_INFORMATION”. This may be understood to indicate the measurement type, which in an example may be set to application related information.

In some examples, the third indication may comprise a second parameter indicating a granularity of the measurement. The second parameter may be, e.g., GranularityofMeasurement. In a particular non-limiting example, the second parameter may indicate that the granularity may be per flow, with, e.g., GranularityofMeasurement=“PER_FLOW”.

In some examples, the third indication may comprise the one or more filters to be applied to the notifications to be provided in response to the third indication. For example, the one or more filters may be indicated with a third parameter, e.g., an Event-Filter parameter, such as e.g., Event-Filter(DNN, S-NSSAI).

According to a second option, the third indication may comprise the second identifier of the one or more devices 130 for which the first information may be requested. That is, the target devices for this event. For example, the second identifier may be AnyUE, as described above.

In a non-limiting example, the third indication may comprise the fourth identifier, the first parameter, the second parameter, the one or more filters, and the second identifier.

The third indication may be, e.g., an Nsmf_EventExposure_Subscribe request indicating {Event-ID=UserDataUsageMeasures, indication to report traffic matching catch-all rule, Event-Filter(DNN, S-NSSAI), AnyUE, Measurement Type=“APPLICATION_RELATED_INFORMATION”, GranularityofMeasurement=“PER_FLOW”}.

The third indication may trigger the seventh node 117 to then select the one or more devices indicated by the second identifier, e.g., individual UEs, e.g., through locally configured sampling for user sessions, filtered according to the one or more filters, e.g., in the target DNN and S-NSSAI, and to trigger one event subscription for each of the one or more devices 130. The seventh node 117 may then send another indication to the fourth node 114. In examples wherein the fourth node 114 may be a UPF, the another indication may be e.g., a Nupf_EventExposure_Subscribe request. The another indication may comprise, in a non-limiting example, the fourth identifier, the further indication, the second identifier, the first parameter, and the second parameter. The another indication may further indicate a second additional indication. The second additional indication may indicate to report the traffic the fourth node 114 may not be able to classify, e.g., matching the default rule, in addition to the App-ID indicated above.

In some examples wherein the first node 111 may perform Action 304, one of the one or more devices 130 may start application traffic. The fourth node 114 may then run a PDR matching procedure, and based on the requested event, store data for each detected flow matching the PDR corresponding to the catch-all rule. Specifically, for each detected flow matching the PDR corresponding to the catch-all rule, the fourth node 114 may store, as non an exhaustive list, a 5-tuple, including the Server IP address. A 5-tuple may consist of 5 parameters in an IP packet: source IP address, server IP address, source port, server port and IP protocol. Optionally, the fourth node 114 may store a volume measurement, which may be understood to measure data volume exchanged, uplink (UL), downlink (DL) and/or overall, and/or number of packets exchanged, UL, DL and/or overall. The fourth node 114 may also store URL/s and/or Domain name/s detected for that flow.

The fourth node 114 may send application traffic to the sixth node 116. The fourth node 114 may continue gathering data for the event identified by the fourth identifier, e.g., Event-ID=UserDataUsageMeasures and, at some point, e.g., periodic reporting, the fourth node 114 may then report the second information for the event identified by the fourth identifier, e.g., Event-ID=UserDataUsageMeasures, to the first node 111. The first node 111 may then receive the report, in examples wherein the first node 111 may be a NWDAF and the fourth node 114 may be a UPF, as a Nupf_EventExposure_Notify request message. The Nupf_EventExposure_Notify request message may comprise, as a non an exhaustive list, the fourth identifier, e.g., Event-ID=UserDataUsageMeasures, the respective second identifier of the device having started the application traffic, as for example, a respective UE-ID, and information reporting the event as, for example, UserDataUsageMeasuresInfo. This may include the following information, stored from previous steps. For each detected flow matching the PDR corresponding to the catch-all rule, as non-exhaustive list: a) the 5-tuple, including the Server IP address, b) optionally, the Volume Measurement, comprising measures of data volume exchanged, UL, DL and/or overall, and/or number of packets exchanged, UL, DL and/or overall, and c) URL/s and/or Domain name/s detected for that flow.

### Action 305

In this Action 305, the first node 111 may determine, based on at least one of: the stored information and the notification of the one or more events, out of the first set of the one or more internet protocol addresses and the second set of the one or more internet protocol addresses: i) a third set of the one or more internet protocol addresses for which it may be known whether the one or more internet protocol addresses in the third set may be, respectively, dedicated to a respective single application or shared by a respective plurality of applications, and ii) a fourth set of the one or more internet protocol addresses for which it may be unknown whether the one or more internet protocol addresses in the fourth set may be, respectively, dedicated to a respective application or shared by a respective plurality of applications.

In some examples, the first node 111 may determine the third set of the one or more internet protocol addresses by checking if, in the stored information in the third node 113, the same internet protocol address is linked with more than one third identifier, e.g., App-ID. If so, the first node 111 may determine such internet protocol address is shared. Alternatively or additionally, the first node 111 may, for example, determine the third set of the one or more internet protocol addresses by checking if, in the stored information in the third node 113 there may be previous mapping information stored for at least one or more of the internet protocol addresses in the third set, see Action 407, 408, 505 and 506.

In some examples, the first node 111 may alternatively or additionally determine the third set of the one or more internet protocol addresses by checking if, in the notified events by the fourth node 114, the same internet protocol address has been used for traffic of more than one application, e.g., with more than one third identifier, e.g., App-ID. If so, the first node 111 may determine such internet protocol address is shared. Alternatively or additionally, the first node 111 may, for example, determine the third set of the one or more internet protocol addresses by cross-referencing any internet protocol addresses for which traffic may have been notified for a single application, with the stored information in the third node 113 to determine if any such internet protocol addresses may be shared or dedicated.

The fourth set of the one or more internet protocol addresses may comprise those internet protocol addresses for which the third node 113 may not have provided stored information, for which the fourth node 114 may not have detected an event, e.g., IP addresses for which none of the one or more user devices 130 may have started application traffic, or which it may otherwise not be possible to determine if an internet protocol address is shared or dedicated, e.g., if the internet protocol address is only associated with traffic of a single application, but it cannot be ruled out with certainty that it is not shared with other applications if e.g., there is no mapping information stored.

### Action 306

In this Action 306, the first node 111 may send a fourth indication to the fifth node 115 operating in the communications system 100.

The fourth indication may request whether the one or more internet protocol addresses in the fourth set may be, respectively, dedicated to a respective single application or shared by a respective plurality of applications.

In some examples wherein the first node 111 may be a NWDAF and the fifth node 115 may be a SAMF, the fourth indication may be a Nsamf_Mapping Request message. The fourth indication may comprise the following parameters: a third additional indication of the one or more internet protocol addresses in the fourth set, as for example, a List of Server IP addresses. The third additional indication may identify the IP addresses of the Application Servers for which the first node 111 may request the fifth node 115 to identify the hosted applications. The fifth node 115 may have a local cache for previously contacted servers, which may indicate whether the one or more internet protocol addresses in the fourth set may be, respectively, dedicated to a respective single application or shared by a respective plurality of applications.

However, it may be that, in some examples, this cache may be either empty or the required entry may not be found. The actions performed by the fifth node 115 in either of these examples are described in full later, in relation to FIG. 7.

### Action 307

In this Action 307, the first node 111 may receive, responsive to the sent fourth indication, a fifth indication from the fifth node 115. The fifth indication may indicate whether the one or more internet protocol addresses in the fourth set may be, respectively, dedicated to a respective single application or shared by a respective plurality of applications.

The fifth indication may comprise a fourth additional indication as a list of the Server IP addresses indicated in the third additional indication, and the corresponding mapping information. The mapping information may indicate if the sixth node 116, e.g., a server corresponding to a Server IP address, may host a single application, and indicating the specific domain, e.g., moviestreamingprovider.com, or multiple applications and, if available, indicating e.g., the generic domain, such as, e.g., cloudservicesprovider.com.

In particular examples wherein the first node 111 may be an NWDAF and the fifth node 115 may be a SAMF, the fourth indication may be an Nsamf_Mapping Response.

### Action 308

In this Action 308, the first node 111 determines the first information indicating whether the one or more internet protocol addresses are, respectively, dedicated to a respective single application, or shared by a respective plurality of applications.

Determining may be understood as checking, calculating, deriving, matching, or similar. Further particularly, in this Action 308, the first node 111 may determine the first information by producing analytics based on the data collected. The first node 111 may produce the new analytic mentioned earlier, indicating a mapping from a respective IP address to the respective single application it may be dedicated to or to the respective plurality of applications the respective IP address may be shared by. As mentioned earlier, this new analytic may be identified as IPtoAppMapping. The first information may comprise a result of the analytic. The result of the analytic may comprise a List of the one or more internet protocol addresses, e.g., Server IP address, and the corresponding mapping information. The mapping information may indicate if the a respective server, such as for example the sixth node 116, corresponding to a respective IP address, may host a single application, and indicating the specific application, e.g. App-ID=moviestreamingprovider and/or domain, e.g., moviestreamingprovider.com, or multiple applications and, if available, indicating e.g., the generic domain, such as, e.g., cloudservicesprovider.com.

In particular examples, the first information may comprise a list of the respective IP addresses and the respective mapping information for each of the respective IP addresses.

In some embodiments, the determining in this Action 308 of the first information may be based on the second information collected from the one or more other nodes 113, 114, 115.

In some embodiments, the determining in this Action 308 of the first information may be based on the received fifth indication.

In some embodiments, the determining in this Action 308 may be performed in response to the obtained first indication. That is, the obtaining of the first indication may ultimately trigger the first node 111 to, after collecting the second information, perform the determination in this Action 308.

### Action 309

In this Action 309, the first node 111 provides the determined first information to the second node 112 operating in the communications system 100.

Initiating may be understood as triggering, starting, facilitating or enabling.

As stated earlier, the first information may comprise the list of the respective IP addresses and the respective mapping information for each of the respective IP addresses.

The first node 111 may, in this Action 309, further provide the first identifier of the analytic indicating the request of the first information. The result of the analytic may be indicated by a fifth identifier referred to herein as AnalyticResult.

In particular examples wherein the first node 111 may be an NWDAF, the first node 111 may provide the determined first information in a Nnwdaf_AnalyticsSubscription_Notify request message comprising the Analytic-ID=IPtoAppMapping, and the AnalyticResult.

In any of the embodiments just described for the method described in FIG. 3, at least one of the following may apply: a) the communications system 100 may be a 5G system, b) the first node 111 may be an NWDAF, c) the second node 112 may be a NEF, d) the one or more other nodes 113, 114, 115 may comprise at least one of: i) the third node 113, the third node 113 being a UDR, ii) the fourth node 114, the fourth node 114 being a UPF, and iii) the fifth node 115, the fifth node 115 being a SAMF, e) the second information collected by the first node 111 may be derived from PFDs, and f) the second information collected by the first node 111 may comprise a list of identifiers of applications and PFDs of Type Server IP received by the first node 111 from the third node 113 via the second node 112.

By providing the determined first information to the second node 112 in this Action 309, the first node 111 may then enable the second node 112 to apply corresponding actions based on the AnalyticResult. The corresponding actions may comprise, specifically, to store in the third node 113, as Application Data, the server IP addresses and their corresponding App-ID, and which server IP addresses may be mapped to multiple applications. This may then enable to correctly perform classification of traffic and thereby enable to apply the appropriate traffic management actions, such as e.g., QoS.

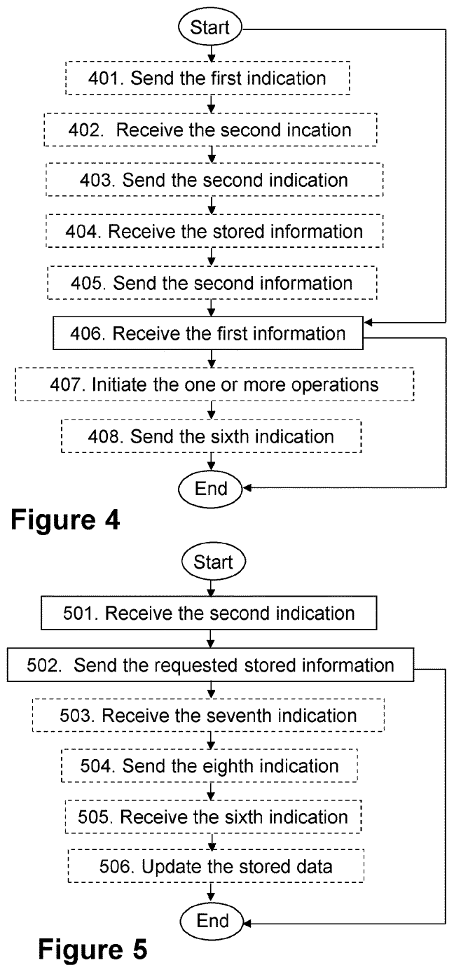

Embodiments of a computer-implemented method performed by the second node 112, will now be described with reference to the flowchart depicted in FIG. 4. The method may be understood to be for handling the one or more internet protocol addresses. The second node 112 operates in the communications system 100.

The method may comprise the following actions. Several embodiments are comprised herein. In some embodiments, the method may comprise all the actions. In other embodiments, the method may comprise one or more actions. One or more embodiments may be combined, where applicable. All possible combinations are not described to simplify the description. It should be noted that the examples herein are not mutually exclusive.

Components from one example may be tacitly assumed to be present in another example and it will be obvious to a person skilled in the art how those components may be used in the other examples. In FIG. 4, optional actions are depicted with dashed lines.

The detailed description of some of the following corresponds to the same references provided above, in relation to the actions described for the first node 111 and will thus not be repeated here to simplify the description. For example, in some examples, the first indication may indicate the request to subscribe to the first node 111 on the new analytic.

### Action 401

In this Action 401, the second node 112 may send the first indication requesting the first information, directly or indirectly, to the first node 111.

As described earlier, the first indication may comprise at least one of the following.

According to the first option, the first indication may comprise the first identifier of the analytic indicating the request of the first information.

According to the second option, the first indication may comprise the second identifier of the one or more devices 130 for which the first information may be being requested.

According to the third option, the first indication may comprise the third identifier of the one or more applications for which the first information may be being requested.

According to the fourth option, the first indication may comprise the one or more filters to be applied to the first information to be provided in response to the first indication.

### Action 402

In this Action 402, the second node 112 may receive the second indication from the first node 111. The second indication may request the stored information at the communications system 100 indicating whether at least the first set of the one or more internet protocol addresses may be, respectively, dedicated to a respective single first application or shared by the respective first plurality of applications.

The receiving of the second indication from the first node 111 may be responsive to the sent first indication.

### Action 403

In this Action 403, the second node 112 may send the second indication to the third node 113 operating in a communications system 100. The second node 112 may thereby initiate a request towards the third node 113 to get the requested PFDs.

The sending of the second indication to the third node 113 may be responsive to the received second indication from the first node 111.

In examples wherein the third node 113 may be a UDR, the second indication sent by the second node 112 in this Action 403 may be a Nudr_Read message comprising the same parameters as the ones in the second indication received in Action 403.

### Action 404

In this Action 404, the second node 112 may receive the stored information from the third node 113. For example, the second node 112 may, in this Action 404, retrieve the PFDs of Type IP for any App-ID.

The receiving of the stored information from the third node 113 may be received in a response message to the sent second indication to the third node 113.

The stored information may indicate whether the first set of the one or more internet protocol addresses may be, respectively, dedicated to a respective single first application or shared by the respective first plurality of applications.

In some embodiments, the second information may comprise the list of identifiers of applications and PFDs of Type Server IP, e. g, as a List of (App-ID, IP PFDs). That is, the list of identifiers of the stored applications, e.g., as an App-ID out of the applications indicated by the third identifier, and their corresponding IP PFDs. In a non-limiting example, this may be including the PFDs of type IP for any App-ID.

### Action 405

In this Action 405, the second node 112 may send the second information indicating the stored information to the first node 111.

The sending of the second information to the first node 111 may be responsive to the received stored information from the third node 113, and may be an answer to the received second indication in Action 402 and may comprise the PFDs of type IP for any App-ID.

Action 406 In this Action 406, the second node 112 receives the first information from the first node 111 operating in the communications system 100. The first information indicates whether the one or more internet protocol addresses re, respectively, dedicated to a respective single application, or shared by the respective plurality of applications.

The first information may be received responsive to the sent first indication in Action 401. That is, the second node 112 may receive a notification from the first node 111, based on the data collected from the one or more other nodes 113, 114, 115, e.g., the NEF, UPF and SAMF, by receiving the Nnwdaf_AnalyticsSubscription_Notify request message comprising the Analytic-ID=IPtoAppMapping, and the AnalyticResult.

In some embodiments, the first information received from the first node 111 may be based on the sent second information in Action 405.

The second node 112 may answer the message comprising the first information with a successful response.

### Action 407

In this Action 407, the second node 112 may initiate the one or more operations in the communications system 100 based on the received first information. That is, the second node 112 may apply the corresponding actions based on the AnalyticResult.

### Action 408

In some embodiments, the one or more operations may comprise at least that in this Action 408, the second node 112 may send a sixth indication to the third node 113 operating in the communications system 100. The sixth indication may request an update of stored data with the received first information in Action 406.

The corresponding actions may comprise, specifically, to store in the third node 113, as Application Data, the server IP addresses and their corresponding App-ID, and which server IP addresses may be mapped to multiple applications.

For the Server IP addresses which may be hosted by a single application, the second node 112 may, in this Action 408, store in the third node 113, as Application Data, the server IP addresses as new PFDs for the corresponding App-ID.

For the Server IP addresses which may be not hosted by a single application, the second node 112 may, in this Action 408, store in the third node 113, e.g., extending the existing Application Data structure, all the server IP addresses which may be not mapped to a single application.

In some examples wherein the second node 112 may be a NEF and the third node 113 may be a UDR, the sixth indication may be e.g., a Nudr_Write message comprising as parameters: a) a fourth parameter indicating a List of the respective third identifier, e.g., App-ID, and the respective list of internet protocol addresses, e.g., as a List of Server IP address, and/or b) a fifth parameter indicating a list of Server IP addresses not mapped to a single application.

In any of the embodiments just described for the method described in FIG. 4, at least one of the following may apply: a) the communications system 100 may be a 5G system, b) the first node 111 may be an NWDAF, c) the second node 112 may be a NEF, d) the third node 113 may be a UDR, e) the second information sent to the first node 111 may be derived from PFDs, and f) the stored information may comprise the list of identifiers of applications and PFDs of Type Server IP.

Embodiments of a computer-implemented method performed by the third node 113, will now be described with reference to the flowchart depicted in FIG. 5. The method may be understood to be for handling the one or more internet protocol addresses. The third node 113 is operating in the communications system 100.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive.

Components from one example may be tacitly assumed to be present in another example and it will be obvious to a person skilled in the art how those components may be used in the other examples. In FIG. 5, optional actions are depicted with dashed lines.

The detailed description of some of the following corresponds to the same references provided above, in relation to the actions described for the first node 111 and will thus not be repeated here to simplify the description. For example, in some embodiments, the first node 111 may be an NWDAF.

### Action 501

In this Action 501, the third node 113 receives the second indication from the first node 111 operating in the communications system 100, directly or indirectly via the second node 112 operating in the communications system 100.

The second indication requests the stored information at the communications system 100 indicating whether at least the first set of the one or more internet protocol addresses are, respectively, dedicated to a respective single first application or shared by a respective first plurality of applications.

### Action 502

In response to the received second indication, the third node 113 may retrieve the stored information, e.g., the PFDs of type IP for any App-ID.

The third node 113, in this Action 502, sends the requested stored information to the first node 111 directly or indirectly via the second node 112.

In some embodiments, after having sent the requested stored information, the method performed by the third node 113 may comprise at least one of Action 503, Action 504, Action 505, and Action 506.

### Action 503

In this Action 503, the third node 113 may receive a seventh indication from the fifth node 115 operating in the communications system 100. The seventh indication may request whether the one or more internet protocol addresses in the fourth set of the one or more internet protocol addresses for which it may be unknown whether the one or more internet protocol addresses in the fourth set may be, respectively, dedicated to a respective application or shared by a respective plurality of applications, may be, respectively, dedicated to a respective single application or shared by a respective plurality of applications.

### Action 504

In some embodiments, the third node 113 may send, in this Action 504, responsive to the receiving seventh indication, an eighth indication to the fifth node 115. The eighth indication may indicate whether the one or more internet protocol addresses in the fourth set may be, respectively, dedicated to a respective single application or shared by a respective plurality of applications.

### Action 505

In some embodiments, the third node 113 may receive, in this Action 505, the sixth indication from the second node 112. The sixth indication may request the update of the stored data with the first information indicating whether the one or more internet protocol addresses may be, respectively, dedicated to a respective single application, or shared by a respective plurality of applications.

### Action 506

In some embodiments, the third node 113 may update, in this Action 506, responsive to the received sixth indication, the stored data with the first information.

In some examples, the third node 113 may update PFDs, e.g., of type Server IP address, for each App-ID. Additionally, the existing ApplicationData structure may be updated in this Action 506, to include the list of Server IP addresses mapped into a single application, and the ones mapped into multiple applications.

The third node 113 may, in some examples, answer the sixth indication in Action 505 with a successful response.

According to some examples, embodiments herein may also enable to update the ApplicationData structure in the third node 113, e.g. in case a certain Server IP address may be initially mapped into a single application, but later on, it may get mapped either to another application or to multiple applications. This may be achieved by using timestamps, when storing data in the ApplicationData structure in the third node 113, and through configurable timeout handling logic at the first node 111.

In any of the embodiments just described for the method described in FIG. 5, at least one of the following may apply: a) the communications system 100 may be a 5G system, b) the first node 111 may be an NWDAF, c) the second node 112 may be a NEF, d) the third node 113 may be a UDR, e) the fifth node 115 may be the SAME, and f) the stored information may comprise the list of identifiers of applications and PFDs of Type Server IP.

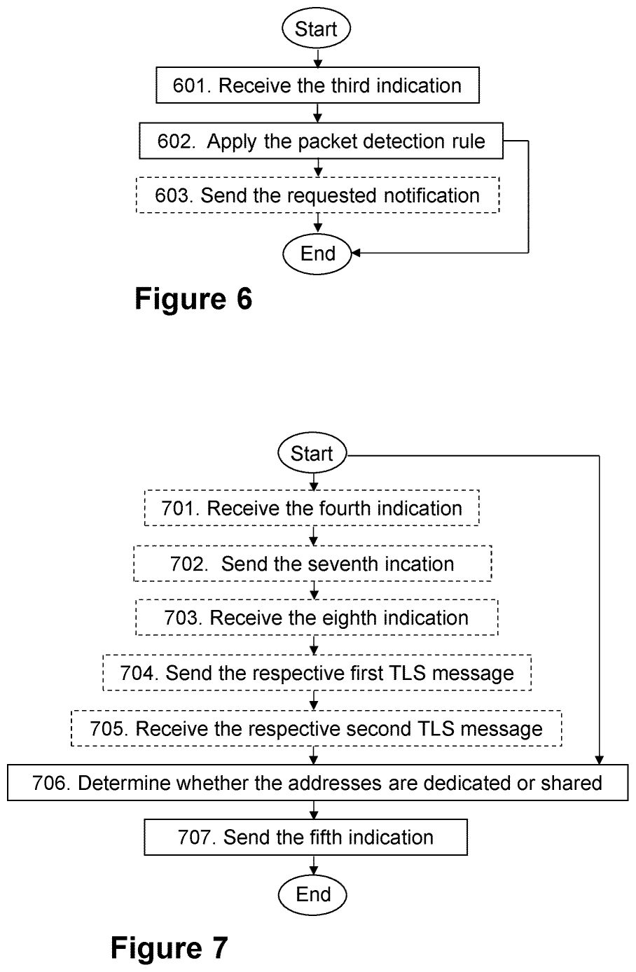

Embodiments of a computer-implemented method performed by the fourth node 114, will now be described with reference to the flowchart depicted in FIG. 6. The method may be understood to be for handling the s one or more internet protocol addresses. The fourth node 114 operates in the communications system 100.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive.

Components from one example may be tacitly assumed to be present in another example and it will be obvious to a person skilled in the art how those components may be used in the other examples. In FIG. 6, optional actions are depicted with dashed lines.

The detailed description of some of the following corresponds to the same references provided above, in relation to the actions described for the first node 111 and will thus not be repeated here to simplify the description. For example, in some embodiments, the third indication may be received indirectly from the first node 111, via the seventh node 117.

### Action 601

In this Action 601, the fourth node 114 receives, directly or indirectly, the third indication from the first node 111 operating in a communications system 100. The third indication requests notification of the one or more events to occur in the communications system 100 based on application traffic. The one or more events indicate whether at least the second set of the one or more internet protocol addresses are, respectively, dedicated to a respective single second application or shared by a respective second plurality of applications.

The fourth node 114 may receive the third indication, specifically to retrieve information relative to user plane traffic detected by the fourth node 11, in some examples, for UE-ID. The network node 111 may have subscribed to the existing event “UserDataUsageMeasures” by sending, via the seventh node 117, a Nsmf_EventExposure_Subscribe. While the event subscription by the first node 111 may be for AnyUE, the seventh node 117 may have selected individual devices, e.g., through locally configured sampling for user sessions in the target DNN and S-NSSAI indicated as the one or more filters, and may have triggered one event subscription for each device with the another indication described earlier. In examples wherein the fourth node 114 may be a UPF, the another indication may be e.g., a Nupf_EventExposure_Subscribe request. The another indication may comprise, in a non-limiting example, the fourth identifier, the further indication, the second identifier, the first parameter, and the second parameter. The another indication may further indicate a second additional indication. The second additional indication may indicate to report the traffic the fourth node 114 may not be able to classify, e.g., matching the default rule, in addition to the App-ID indicated above. In a particular example, the Nupf_EventExposure_Subscribe request may comprise {Event-ID=UserDataUsageMeasures, indication to report traffic matching catch-all rule, UE-ID, Measurement Type=“APPLICATION_RELATED_INFORMATION”, GranularityofMeasurement=“PER_FLOW”}.

The fourth node 114 may answer the request message with a successful response, accepting the request. This may trigger the seventh node 117 to also answer the request message with a successful response, accepting the request.

### Action 602

In some examples wherein the first node 111 may perform Action 304, one of the one or more devices 130 may start application traffic. The fourth node 114, in this Action 602, may apply a packet detection rule procedure to detected traffic based on the received third indication. The fourth node 114 may run a PDR matching procedure, and based on the requested event, store data for each detected flow matching the PDR corresponding to the catch-all rule. Specifically, for each detected flow matching the PDR corresponding to the catch-all rule, the fourth node 114 may store, as non an exhaustive list, a 5-tuple, including the Server IP address. Optionally, the fourth node 114 may store a volume measurement, which may be understood to measure data volume exchanged, uplink (UL), downlink (DL) and/or overall, and/or number of packets exchanged, UL, DL and/or overall. The fourth node 114 may also store URL/s and/or Domain name/s detected for that flow.

The fourth node 114 may send application traffic to the sixth node 116.

### Action 603

The fourth node 114 may continue gathering data for the event identified by the fourth identifier, e.g., Event-ID=UserDataUsageMeasures and, at some point, e.g., periodic reporting, the fourth node 114 may then report the second information for the event identified by the fourth identifier, e.g., Event-ID=UserDataUsageMeasures, to the first node 111.

In this Action 603, the fourth node 114 sends the requested notification to the first node 111. The sent requested notification is based on the applied packet detection rule procedure. The fourth node 114 may send the report, in examples wherein the fourth node 114 may be a UPF, as a Nupf_EventExposure_Notify request message. The Nupf_EventExposure_Notify request message may comprise, as a non an exhaustive list, the fourth identifier, e.g., Event-ID=UserDataUsageMeasures, the respective second identifier of the device having started the application traffic, as for example, a respective UE-ID, and information reporting the event as, for example, UserDataUsageMeasuresInfo. This may include the following information, stored from previous steps. For each detected flow matching the PDR corresponding to the catch-all rule, as non-exhaustive list: a) the 5-tuple, including the Server IP address, b) optionally, the Volume Measurement, comprising measures of data volume exchanged, UL, DL and/or overall, and/or number of packets exchanged, UL, DL and/or overall, and c) URL/s and/or Domain name/s detected for that flow.

In any of the embodiments just described for the method described in FIG. 6, at least one of the following may apply: a) the communications system 100 may be a 5G system, b) the first node 111 may be an NWDAF, c) the fourth node 114 may be a UPF.

Embodiments of a computer-implemented method performed by the fifth node 115, will now be described with reference to the flowchart depicted in FIG. 7. The method may be understood to be for handling the one or more internet protocol addresses. The fifth node 115 operates in the communications system 100.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive.

Components from one example may be tacitly assumed to be present in another example and it will be obvious to a person skilled in the art how those components may be used in the other examples. In FIG. 7, optional actions are depicted with dashed lines.

The detailed description of some of the following corresponds to the same references provided above, in relation to the actions described for the first node 111 and will thus not be repeated here to simplify the description. For example, in some examples, the fifth node 115 may be a SAMF.

### Action 701

In this Action 701, the fifth node 115 receives the fourth indication from the first node 111 operating in the communications system 100. The fourth indication requests whether the one or more internet protocol addresses in the fourth set of the one or more internet protocol addresses for which it is unknown whether the one or more internet protocol addresses in the fourth set are, respectively, dedicated to a respective application or shared by a respective plurality of applications are, respectively, dedicated to a respective single application or shared by a respective plurality of applications.

### Action 702

In response to the received fourth indication, the fifth node 115 may check if each Server IP, e.g. Server IP #X, may have already been mapped before. In order to do this, in this Action 702, the fifth node 115 may send, responsive to the received fourth indication, a seventh indication to the third node 113 operating in the communications system 100. The seventh indication may request whether the one or more internet protocol addresses in the fourth set may be, respectively, dedicated to a respective single application or shared by a respective plurality of applications.

In particular examples wherein the third node 113 may be a UDR, the seventh indication may be a Nudr_Get Request message.

The seventh indication may comprise the one or more internet protocol addresses in the fourth set, e.g., as the parameter Server IP address. This may identify the IP address of the Application Server to be mapped.

### Action 703

In response to the seventh indication, the third node 113 may looks in the database for Mobile Network Operator (MNO) mapped servers, e.g., as an extension of the Application Data structure, to check if there may be a previous mapping stored for each Server IP, e.g., Server IP #X.

In this Action 703, the fifth node 115 may receive, responsive to the sent seventh indication, an eighth indication from the third node 113. The eighth indication may indicate whether the one or more internet protocol addresses in the fourth set are, respectively, dedicated to a respective single application or shared by a respective plurality of applications. The respective first message may be sent based on the received eighth indication.

If no previous record is found by the third node 113, the eight indication may indicate that: “Not Found”.

In some examples, wherein the third node 113 may be a UDR, the eighth indication may be a Nudr_Get Response message.

### Action 704

In this Action 704, the fifth node 115 may send, responsive to the received fourth indication, a respective first Transport Layer Security (TLS) message to at least a first subset of the one or more internet protocol addresses in the fourth set. The respective first TLS message may be a client Hello message excluding a server name indication (SNI). In other words, in this Action 704, the fifth node 115 may trigger a connection towards Server IP, e.g., Server IP #X, and trigger TLS handshake with no SNI in the Client Hello message. The respective first TLS message may comprise TCP setup signaling and TLS Client Hello.

The SNI may be understood to be an extension of TLS to allow a physical server to have several virtual servers with different certificates. Without SNI in place, after a Client Hello, the physical server may not now to which virtual server the client may be attempting to connect to, thus only one virtual server may be behind a physical server. With the SNI in place, the physical server may know to which virtual server the client may be attempting to connect to, and it may forward the handshake. This may allow hosting providers, such as public cloud, Content Delivery Network (CDN) providers ..., to use one single IP for several customers or exclusive IPs, one IP per each customer. Currently, all modern servers may support SNI, either when one single IP may be dedicated to one Application or when one single IP may be shared among several applications. This may be exploited to discover when an IP may be exclusively dedicated to one Application or when it may be shared, by later inspecting the certificate resulting from a Client Hello without SNI, in Action 706.

One of the one or more internet protocol addresses in the fourth set may correspond to the sixth node 116.

The fifth node 115 may perform Action 704 responsive to the received eighth indication. The fifth node 115 may have sent the seventh indication prior to sending the respective first TLS message.

### Action 705

In response to the respective first TLS message, the sixth node 116, e.g., an Application Server, may complete the TLS handshake.

In this Action 705, the fifth node 115 may receive, in response to the sent respective first TLS message, at least one respective second TLS message from at least one of the one or more internet protocol addresses in the first subset of the fourth set, such as the sixth node 116. The respective second TLS message may comprise a respective certificate of a respective server 116 associated with the respective one or more internet protocol addresses in the fourth set.

The respective second TLS message ay comprise a TLS Server Hello and the TLS Server Certificate, which may comprise the certificate.

### Action 706

In this Action 706, the fifth node 115 may determine, based on the received respective certificate, whether at least one of the one or more internet protocol addresses in the fourth set may be, respectively, dedicated to a respective single application or shared by a respective plurality of applications. Based on the certificate, the fifth node 115 may derive if the server IP address may be hosted by one or multiple applications as follows. If the respective second TLS message, e.g., the TLS Server Hello and Server Certificate messages, comprises a certificate which is specific for an application, by looking into the certificate domain, this may be understood to mean that the Server IP address is dedicated to that single application. If the respective second TLS message, e.g., the TLS Server Hello and Server Certificate messages comprise a generic certificate, e.g., the domain part of the certificate is cloudservicesprovider, this may be understood to mean that the Server IP address in principle is not dedicated to a single application. If there is no response, it may be understood to be unknown if the server is dedicated to one application. The fifth node 115, in some examples, may assume it is not.

As an example, the IP address 12.345.67.899 owned by Browsercompany.com may be associated to “Application X” because the Subject Alternative Name resulting from a TLS handshake without SNI is “Application X INC”. According to embodiments herein, subnets, e.g., all the IP addresses of Browser Company Cloud, may be identified, and it may be discovered which of those IP addresses may be e.g., assigned by Browser Company Cloud to their clients for exclusive use. A mapping may be created between certificates and applications, e.g., if the subject common name field includes Application X INC, Application X cdn, etc, those may pertain to the Application X application. This may enable to assign Server IP addresses to applications via certificate inspection.

### Action 707

In this Action 707, the fifth node 115 sends, responsive to the received fourth indication, a fifth indication to the first node 111. The fifth indication indicates whether the one or more internet protocol addresses in the fourth set are, respectively, dedicated to a respective single application or shared by a respective plurality of applications.

The fifth indication may be based on a result of the determination in Action 706.

The fifth indication may be based on the respective certificate.

In examples wherein the fifth node 115 may be a SAMF, the fifth indication may be a Nsamf_Mapping Response.

As described earlier, the fifth indication may comprise the fourth additional indication as the list of the Server IP addresses indicated in the third additional indication, and the corresponding mapping information. For example, the fifth indication may comprise {List of (Server IP address, mapping information}.

In any of the embodiments just described for the method described in FIG. 7, at least one of the following may apply: a) the communications system 100 may be a 5G system, b) the first node 111 may be an NWDAF, c) the third node 113 may be a UDR, and d) the fifth node 115 may be a SAMF.

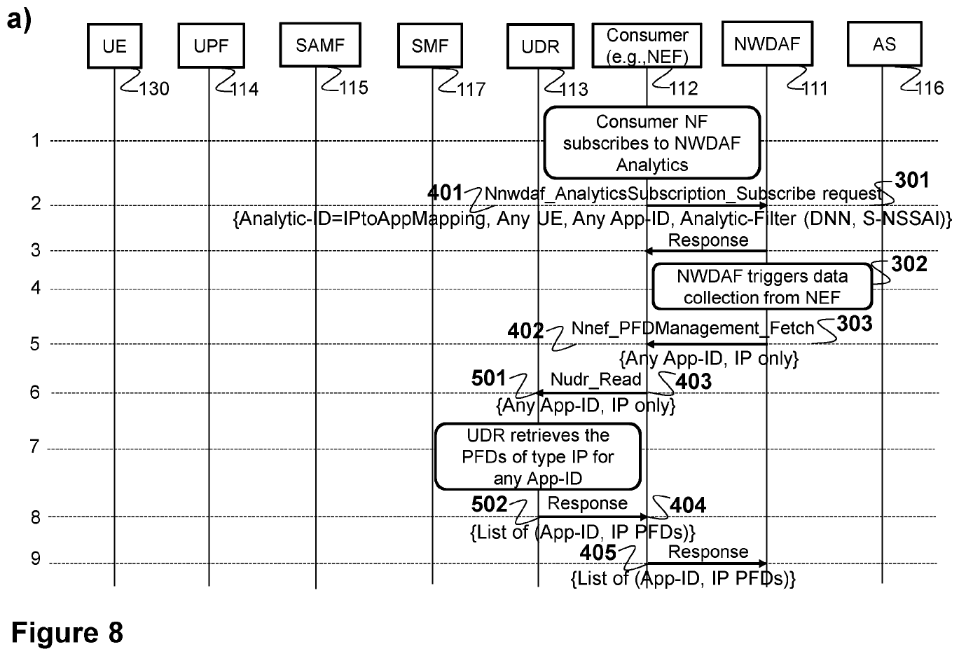

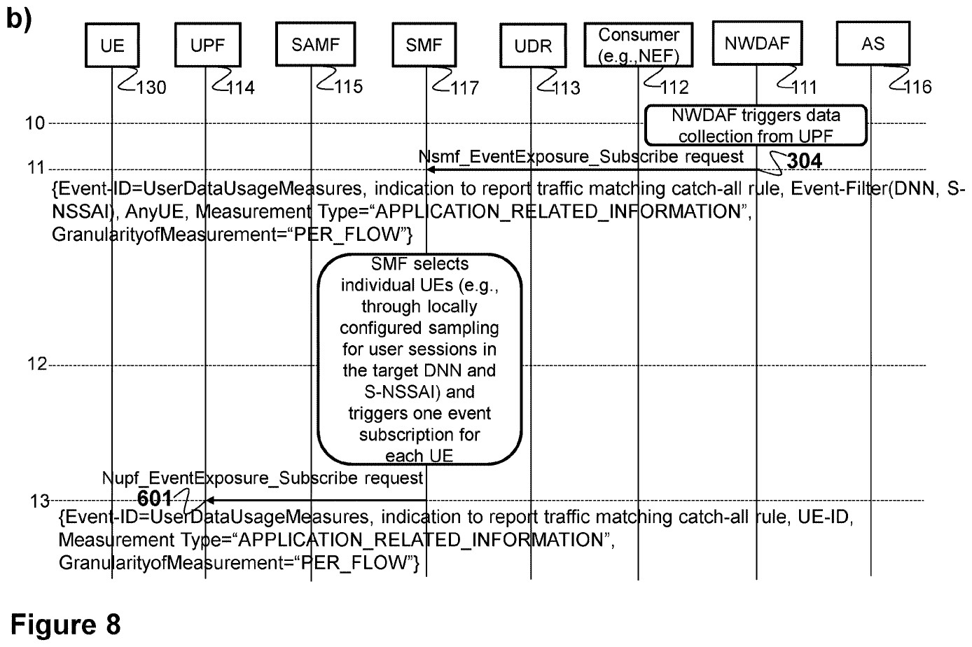

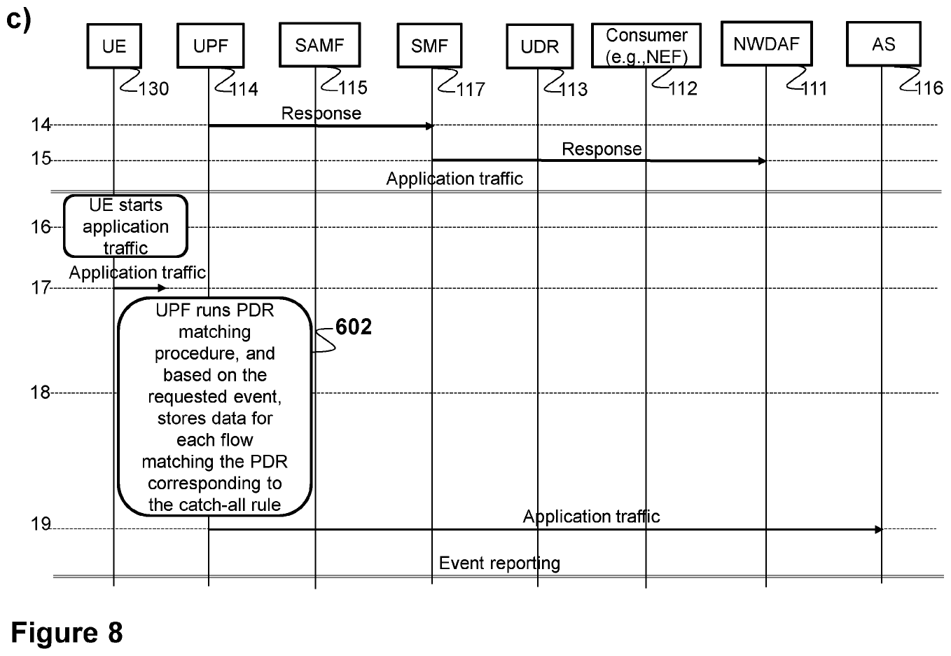

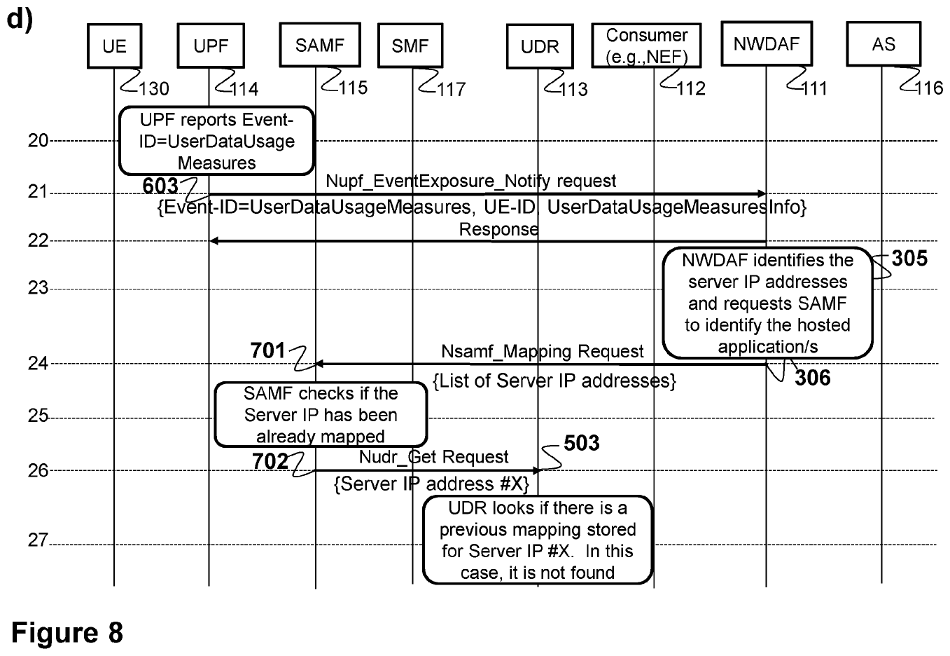

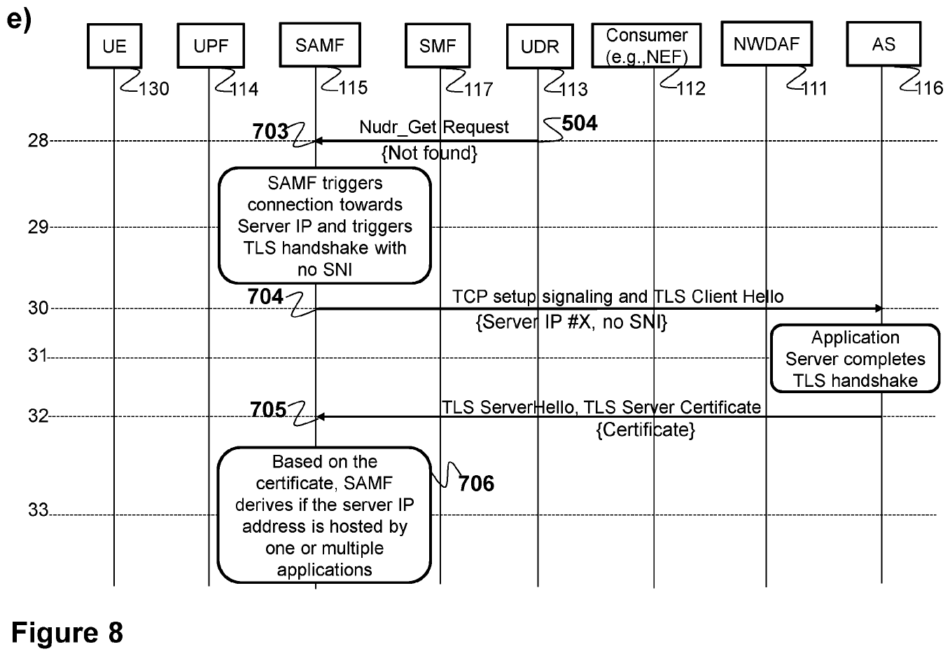

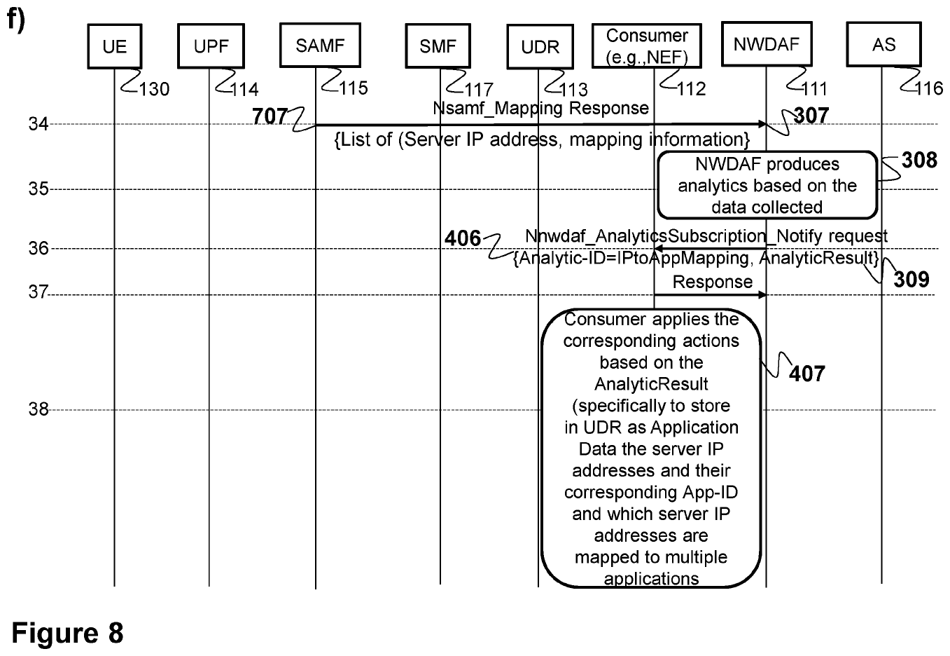

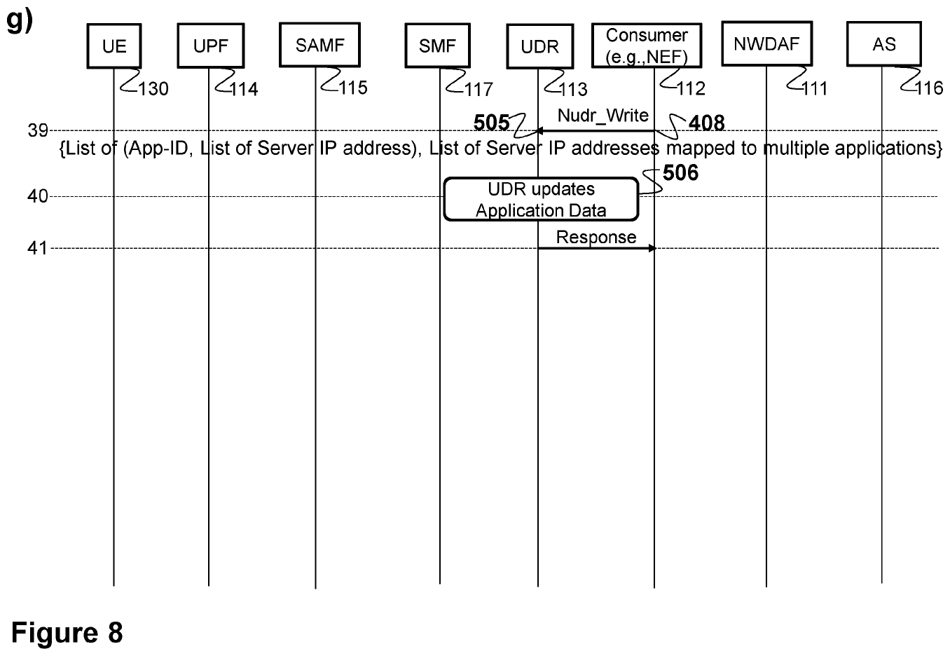

FIG. 8 is a signalling diagram depicting a non-limiting example of a method performed in the communications system 100, according to embodiments herein, over panels a), b), c), d), f) and g). In FIG. 8, the communications system 100 is a 5G network, the first node 111 is an NWDAF, the first second node a consumer, e.g., a NEF, the third node 113 is a UDR, the fourth node 114 is a UPF, the fifth node 115 is an SAMF, the sixth node 116 is an Application Server (AS) of a content provider, the seventh node 117 is an SMF and the device 130 is a UE. It may be understood that in the following example depicted in FIG. 8, any reference to the NWDAF may be understood to equally refer to the first node 111, any reference to the NEF may be understood to equally refer to the second node 112, any reference to the UDR may be understood to equally refer to the third node 113, any reference to the UPF may be understood to equally refer to the fourth node 114, any reference to the SAMF may be understood to equally refer to the fifth node 115, any reference to the AS may be understood to equally refer to the sixth node 116, any reference to the SMF may be understood to equally refer to the seventh node 117, and any reference to the UE may be may be understood to equally refer to the device 130. Starting on panel a), in Steps 1 and 2), A consumer, e.g., NEF, according to Action 401 and Action 301, subscribes to the NWDAF on the new analytic, Analytic-ID=IPtoAppMapping, by triggering a Nnwdaf_AnalyticsSubscription_Subscribe request message including the following parameters: a) Analytic-ID=IPtoAppMapping, b) AnyUE; This may be understood to indicate the UE/s which may be the target for this analytic, c) Any App-ID; this may be understood to indicate the application/s which may be the target for this analytic, and d) Other filter information such as DNN, S-NSSAI. In Step 3, the NWDAF may answer the request message in Step 2 with a successful response, accepting the request. In Steps 4 and 5, the NWDAF may, according to Action 302, trigger data collection from the NEF to retrieve the PDFs of Type Server IP address, from the 3-tuples, on a per application basis. Neither domain names nor URLs may need to be retrieved. To do this, the NWDAF may, according to Action 303 and Action 402, trigger a Nnef_PFDManagement_Fetch request message indicating as parameters Any App-ID and an indication to retrieve (server) IP only information. In Step 6, the NEF may initiate, according to Action 403 and Action 501, a request towards UDR to get the requested PFDs, e.g. by triggering a Nudr_Read message including the same parameter as the ones in the message in Step 5 above. In Steps 7 and 8, the UDR may retrieve the PFDs of type IP for any App-ID and may send them, according to Action 502 and Action 404, to the NEF in a response message as List of (App-ID, IP PFDs).

In Step 9, the NEF, according to Action 405, may answer the message in step 5 including the PFDs of type IP for any App-ID. Continuing in panel b) of FIG. 8, in Steps 10 and 11, the NWDAF may trigger data collection from the UPF, e.g. via the SMF, specifically to retrieve information relative to user plane traffic detected by the UPF for UE-ID. This may be performed using the existing event “UserDataUsageMeasures”. To do this, the NWDAF may, according to Action 304, trigger, via the SMF, a Nsmf_EventExposure_Subscribe request message including the following parameters: a) Event-ID=UserDataUsageMeasures, b) the indication to report the traffic matching the catch-all rule, c) Event-Filter, including: DNN, S-NSSAI, d) AnyUE; this may indicate the target UE/s for this event, e) MeasurementType=“APPLICATION_RELATED_INFORMATION”; this may indicate the measurement type, which in this case may be set to application related information, which may be to request URL/s and/or Domain name/s detected in the PDU Session for the target traffic, and f) GranularityOfMeasurement=“PER_FLOW; This may indicate the granularity of the measurement, which in this case is per flow. In Steps 12 and 13, as the NWDAF event subscription is for AnyUE, the SMF may first select individual UEs, e.g., through locally configured sampling for user sessions in the target DNN and S-NSSAI, and trigger one event subscription for each UE, by triggering towards the UPF, according to Action 601, a Nupf_EventExposure_Subscribe request message including the following parameters: a) Event-ID=UserDataUsageMeasures, b) the indication to report the traffic the UPF may not be able to classify, e.g., matching the default rule, in addition to the App-ID indicated above, c) UE-ID; this may indicate the target UE/s for this event, d) MeasurementType=”APPLICATION_RELATED_INFORMATION“; This may indicate the measurement type, which in this case may be set to application related information, which may be understood to be to request URL/s and/or Domain name/s detected in the PDU Session for the target traffic, and e) GranularityOfMeasurement=”PER_FLOW; This may be understood to indicate the granularity of the measurement, which in this case it is per flow. Continuing in panel c) of FIG. 8, in Step 14, the UPF may answer the request message in Step 13 with a successful response, accepting the request. In Step 15, the SMF may answer the request message in Step 11 with a successful response, accepting the request. In Steps 16 and 17, the user may start application traffic. In Steps 18 and 19, the UPF may, according to Action 602, run a PDR matching procedure, and based on the requested event, may store data for each flow matching the PDR corresponding to the catch-all rule, specifically: for each detected flow matching the PDR corresponding to the catch-all rule, not an exhaustive list: a) 5-tuple, including the Server IP address, b) Optionally, Volume Measurement, which may be understood to measure data volume exchanged, UL, DL and/or overall, and/or number of packets exchanged, UL, DL and/or overall and c) URL/s and/or Domain name/s detected for that flow. Continuing in panel d) of FIG. 8, in Steps 20 and 21, the UPF may continue gathering data for Event-ID=UserDataUsageMeasures and at some point, e.g., periodic reporting, the UPF may, according to Action 603, report data for Event-ID=UserDataUsageMeasures. To do that, the UPF may notify the NWDAF by triggering Nupf_EventExposure_Notify request message including the following parameters: a) Event-ID=UserDataUsageMeasures, b) UE-ID, c) UserDataUsageMeasuresInfo; This may include the following information, stored from previous steps. For each detected flow matching the PDR corresponding to the catch-all rule, not an exhaustive list: i) 5-tuple (including the Server IP address, ii) optionally, Volume Measurement; which may be understood to measure data volume exchanged, UL, DL and/or overall, and/or number of packets exchanged, UL, DL and/or overall, and iii) URL/s and/or Domain name/s detected for that flow. In Step 22, the NWDAF may answer the message in Step 21 with a successful response. In Steps 23 and 24, the NWDAF may, according to Action 305, identify the Server IP addresses and, according to Action 306 and Action 701, request the SAMF to identify the hosted application/s by triggering a Nsamf_Mapping Request message including the parameter List of Server IP addresses.

This may be understood to identify the IP addresses of the Application Servers for which to identify the hosted applications. The SAMF may have a local cache for previously contacted servers. In this example, it is assumed this cache is either empty or the required entry is not found. In Steps 25 and 26) the SAME may check if each Server IP, e.g., Server IP #X, may have already been mapped before, by the SAMF, according to Action 702 and Action 503, triggering towards the UDR a Nudr_Get Request message including the parameter Server IP address. This may be understood to identify the IP address of the Application Server to be mapped. In Step 27) the UDR may looks in the database for MNO mapped servers, e.g., as an extension of the Application Data structure, if there may be a previous mapping stored for each Server IP, e.g., Server IP #X. In this case, it is not found. Therefore, continuing in panel e) of FIG. 8, in Step 28), the UDR, according to Action 504 and Action 703, may answer the SAMF with a Nudr_Get Response message indicating that, that is, Not Found). In Steps 29 and 30), the SAMF may trigger a connection towards the Server IP, e.g., Server IP #X, and trigger, according to Action 704, a TLS handshake with no SNI in the Client Hello message. In Step 31 and 32), the Application Server may, according to Action 705, complete the TLS handshake. For simplicity, this is shown in the sequence diagram in a single step, which includes the TLS Server Hello and the TLS Server Certificate, which includes the certificate.

In Step 33), based on the certificate, the SAMF may, according to Action 706, derive if the server IP address may be hosted by one or multiple applications as follows. If the TLS Server Hello and Server Certificate messages include a certificate which is specific for an application, by looking into the certificate domain, this may be understood to mean that the Server IP address is dedicated to that single application. If the TLS Server Hello and Server Certificate messages include a generic certificate, e.g., the domain part of the certificate is cloudservicesprovider.com, this may be understood to mean that the Server IP address in principle is not dedicated to a single application. If there is no response, it may be unknown if the server is dedicated to one application. The fifth node 115 may assume it is not.

Continuing in panel f) of FIG. 8, in Step 34) the SAMF, according to Action 707 and Action 307, may answer the message in Step 24 above including the following information: a List of: Server IP address and Mapping information. This may be understood to indicate if the server, e.g., Server IP address, may host a single application, and indicating the specific domain e.g. moviestreamingprovider.com, or multiple applications, and if available, indicating e.g., the generic domain like cloudservicesprovider.com. In Steps 35 and 36), the NWDAF, based on the data collected from the NEF, the UPF and the SAMF, may, according to Action 308, produce analytics based on the data collected, and then, according to Action 309 and Action 406, notify the Consumer, e.g., the NEF, by triggering a Nnwdaf_AnalyticsSubscription_Notify request message including the following parameters: a) Analytic-ID=IPtoAppMapping, b) AnalyticResult; this may include the following information: a List of: i) Server IP address and ii) Mapping information. This may be understood to indicate if the server, e.g., Server IP address, may host a single application, and indicating the specific application, e.g., App-ID=moviestreamingprovider and/or domain e.g., moviestreamingprovider.com, or multiple applications, and if available, indicating e.g., the generic domain such as cloudservicesprovider.com. In Step 37), the Consumer may answer the message in Step 36 with a successful response. In Step 38), the Consumer, e.g., NEF, may, according to Action 407, apply the corresponding actions based on the AnalyticResult, specifically: For the Server IP addresses which are hosted by a single application, store in the UDR, as Application Data, the server IP addresses as new PFDs for the corresponding App-ID. For the Server IP addresses which are not hosted by a single application, store in the UDR, e.g., by extending the existing Application Data structure, all the server IP addresses which are not mapped to a single application. Continuing in panel g) of FIG. 8, in Step 39), the NEF may, according to Action 408 and Action 505, initiate a request towards the UDR by triggering e.g., a Nudr_Write message including as parameters: a List of (App-ID, List of Server IP address), and a List of Server IP addresses not mapped to a single application. In Step 40), the UDR may update, according to Action 506, the PFDs, of type Server IP address, for each App-ID. Additionally, the existing ApplicationData structure may be updated to include the list of Server IP addresses mapped into a single application, and the ones mapped into multiple applications. In Step 41), the UDR may answer the message in Step 39 with a successful response.

Although not shown in the sequence diagram in FIG. 8, embodiments herein may also allow to dynamically update the ApplicationData structure in the UDR, e.g. in case a certain Server IP address may be initially mapped into a single application, but later on, it may get mapped either to another application or to multiple applications. This may be achieved by using timestamps, when storing data in the ApplicationData structure in UDR, and through configurable timeout handling logic at the NWDAF. The sequence diagram example in FIG. 8 shows the case of a new analytic. Alternatively, the existing PFD Determination analytic may be updated to derive new/updated PFDs of type Server IP address, in this case by ensuring the Server IP address/es host a single application.

Certain embodiments disclosed herein may provide one or more of the following technical advantage(s), which may be summarized as follows.

Embodiments herein may be understood to allow the network operator to discover server IP addresses and how they may map into applications in a simple, automatic, and efficient way. With the embodiments herein, the MNO may improve the accuracy of traffic classification, even in a context of fully encrypted traffic.

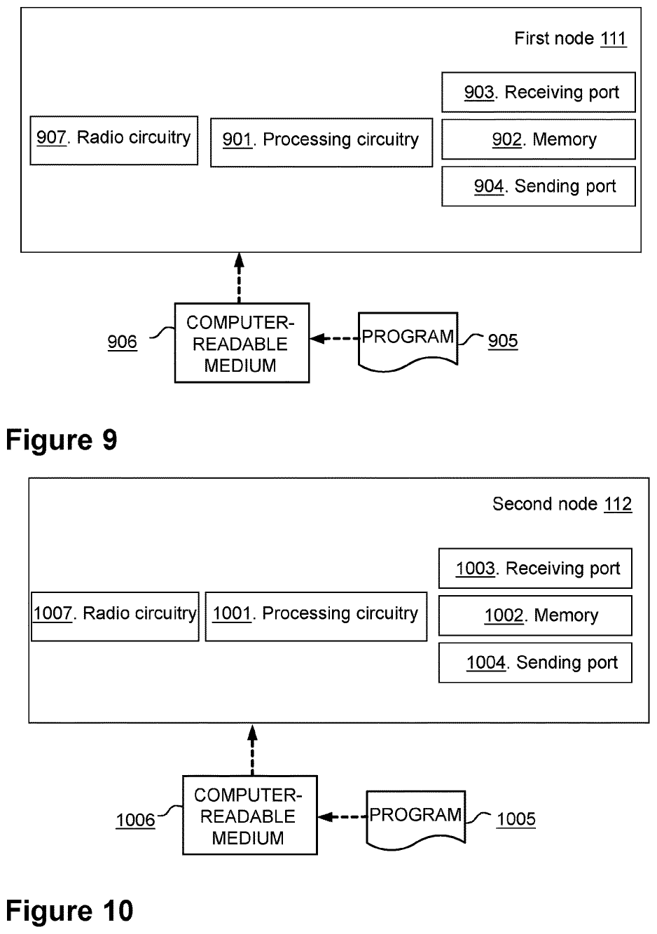

FIG. 9 depicts an example of the arrangement that the first node 111 may comprise to perform the method described in FIG. 3 and/or FIG. 8. The first node 111 may be understood to be for handling the one or more internet protocol addresses. The first node 111 is configured to operate in the communications system 100.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, in some examples, the first indication may indicate the request to subscribe to the first node 111 on the new analytic. The first node 111 is configured to determine the first information configured to indicate whether the one or more internet protocol addresses are, respectively, configured to be dedicated to a respective single application, or shared by a respective plurality of applications. The first node 111 is also configured to provide the determined first information to the second node 112 configured to operate in the communications system 100.

In some embodiments, the first node 111 may be also configured to obtain the first indication, directly or indirectly, from the second node 112. The first indication may be configured to request the first information. The determining may be configured to be performed in response to the first indication configured to be obtained.

In some embodiments, the first node 111 may be also configured to initiate collecting second information configured to indicate the first information from the one or more other nodes 113, 114, 115 operating in the communications system 100. The determining of the first information may be configured to be based on the second information configured to be collected from the one or more other nodes 113, 114, 115.

In some embodiments, the first indication may be configured to comprise at least one of: a) the first identifier of the analytic configured to indicate the request of the first information, b) the second identifier of the one or more devices 130 for which the first information may be configured to be requested, c) the third identifier of the one or more applications for which the first information may be configured to be requested, and d) the one or more filters to be applied to the first information configured to be to be provided in response to the first indication.

In some embodiments, the initiating of the collection of the second information may be configured to comprise to, at least one of: a) send, directly or indirectly, the second indication to the third node 113 configured to operate in the communications system 100; the second indication may be configured to request the stored information at the communications system 100 configured to indicate whether at least the first set of the one or more internet protocol addresses may be, respectively, configured to be dedicated to a respective single first application or shared by a respective first plurality of applications, and b) send, directly or indirectly, the third indication to the fourth node 114 configured to operate in the communications system 100; the third indication may be configured to request the notification of the one or more events to occur in the communications system 100 based on the application traffic; the one or more events may be configured to indicate whether at least the second set of the one or more internet protocol addresses may be, respectively, configured to be dedicated to a respective single second application or shared by a respective second plurality of applications.

In some embodiments, the first node 111 may be further configured to initiate determine, based on at least one of: the stored information and the notification of the one or more events, out of the first set of the one or more internet protocol addresses and the second set of the one or more internet protocol addresses: i) the third set of the one or more internet protocol addresses for which it may be known whether the one or more internet protocol addresses in the third set may be, respectively, configured to be dedicated to a respective single application or shared by a respective plurality of applications, and ii) the fourth set of the one or more internet protocol addresses for which it may be unknown whether the one or more internet protocol addresses in the fourth set may be, respectively, configured to be dedicated to a respective application or shared by a respective plurality of applications.

In some embodiments, the first node 111 may be further configured to send the fourth indication to the fifth node 115 configured to operate in the communications system 100. The fourth indication may be configured to request whether the one or more internet protocol addresses in the fourth set may be, respectively, configured to be dedicated to a respective single application or shared by a respective plurality of applications.

In some embodiments, the first node 111 may be further configured to receive, responsive to the fourth indication configured to be sent, the fifth indication from the fifth node 115. The fifth indication may be configured to indicate whether the one or more internet protocol addresses in the fourth set may be, respectively, configured to be dedicated to a respective single application or shared by a respective plurality of applications. The determining of the first information may be configured to be based on the fifth indication configured to be received.

In some embodiments, at least one of the following may apply: a) the communications system 100 may be configured to be a Fifth Generation, 5G, system, b) the first node 111 may be configured to be a NWDAF, c) the second node 112 may be configured to be a NEF, d) the one or more other nodes 113, 114, 115 may be configured to comprise at least one of: i) the third node 113, the third node 113 being a UDR, ii) the fourth node 114, the fourth node 114 being configured to be a UPF, and iii) the fifth node 115, the fifth node 115 being configured to be a SAMF, e) the second information configured to be collected by the first node 111 may be configured to be derived from PFDs, and f) the second information configured to be collected by the first node 111 may be configured to comprise the list of identifiers of applications and PFDs of Type Server IP configured to be received by the first node 111 from the third node 113 via the second node 112.

The embodiments herein in the first node 111 may be implemented through one or more processors, such as a processing circuitry 901 in the first node 111 depicted in FIG. 9, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 902 comprising one or more memory units. The memory 902 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, the fifth node 115, the sixth node 116, the seventh node 117, the one or more nodes 113, 114, 115, the radio network node 140, the one or more devices 130, another node, and/or another structure in the communications system 100, through a receiving port 903. In some embodiments, the receiving port 903 may be, for example, connected to one or more antennas in first node 111. In other embodiments, the first node 111 may receive information from another structure in the communications system 100 through the receiving port 903. Since the receiving port 903 may be in communication with the processing circuitry 901, the receiving port 903 may then send the received information to the processing circuitry 901. The receiving port 903 may also be configured to receive other information.

The processing circuitry 901 in the first node 111 may be further configured to transmit or send information to e.g., the second node 112, the third node 113, the fourth node 114, the fifth node 115, the sixth node 116, the seventh node 117, the one or more nodes 113, 114, 115, the radio network node 140, the one or more devices 130, another node, and/or another structure in the communications system 100, through a sending port 904, which may be in communication with the processing circuitry 901, and the memory 902.

Those skilled in the art will also appreciate that the units comprised within the first node 111 described above as being configured to perform different actions, may refer to a combination of analog and digital circuits, and/or one or more processors configured with software and/or firmware, e.g., stored in memory, that, when executed by the one or more processors such as the processing circuitry 901, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 111 described above as being configured to perform different actions described above may be implemented as one or more applications running on one or more processors such as the processing circuitry 901.

Thus, the methods according to the embodiments described herein for the first node 111 may be respectively implemented by means of a computer program 905 product, comprising instructions, i.e., software code portions, which, when executed on at least one processing circuitry 901, cause the at least one processing circuitry 901 to carry out the actions described herein, as performed by the first node 111. The computer program 905 product may be stored on a computer-readable storage medium 906. The computer-readable storage medium 906, having stored thereon the computer program 905, may comprise instructions which, when executed on at least one processing circuitry 901, cause the at least one processing circuitry 901 to carry out the actions described herein, as performed by the first node 111. In some embodiments, the computer-readable storage medium 906 may be a non-transitory computer-readable storage medium, such as a CD ROM disc, or a memory stick. In other embodiments, the computer program 905 product may be stored on a carrier containing the computer program 905 just described, wherein the carrier is one of an electronic signal, optical signal, radio signal, or the computer-readable storage medium 906, as described above.

The first node 111 may comprise a communication interface configured to facilitate, or an interface unit to facilitate, communications between the first node 111 and other nodes or devices, e.g., the second node 112, the third node 113, the fourth node 114, the fifth node 115, the sixth node 116, the seventh node 117, the one or more nodes 113, 114, 115, the radio network node 140, the one or more devices 130, another node, and/or another structure in the communications system 100. The interface may, for example, include a transceiver configured to transmit and receive radio signals over an air interface in accordance with a suitable standard.

In other embodiments, the first node 111 may comprise a radio circuitry 907, which may comprise e.g., the receiving port 903 and the sending port 904.

The radio circuitry 907 may be configured to set up and maintain at least a wireless connection with the second node 112, the third node 113, the fourth node 114, the fifth node 115, the sixth node 116, the seventh node 117, the one or more nodes 113, 114, 115, the radio network node 140, the one or more devices 130, another node, and/or another structure in the communications system 100. Circuitry may be understood herein as a hardware component.

Hence, embodiments herein also relate to the first node 111 operative to operate in the communications system 100. The first node 111 may comprise the processing circuitry 901 and the memory 902, said memory 902 containing instructions executable by said processing circuitry 901, whereby the first node 111 is further operative to perform the actions described herein in relation to the first node 111, e.g., in FIG. 3 and/or FIG. 8.

FIG. 10 depicts an example of the arrangement that the second node 112 may comprise to perform the method described in FIG. 4 and/or FIG. 8. The second node 112 may be understood to be for handling the one or more internet protocol addresses. The second node 112 are configured to operate in the communications system 100.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 111 and will thus not be repeated here. For example, in some examples, the first indication may be configured to indicate the request to subscribe to the first node 111 on the new analytic.

The second node 112 is configured to receive the first information from the first node 111 configured to operate in the communications system 100. The first information is configured to indicate whether the one or more internet protocol addresses are, respectively, configured to be dedicated to a respective single application, or shared by a respective plurality of applications.

The second node 112 may be also configured to send the first indication configured to request the first information, directly or indirectly, to the first node 111. The first information may be configured to be received responsive to the first indication configured to be sent.

The second node 112 may be also configured to initiate the one or more operations in the communications system 100 based on the first information configured to be received.

The second node 112 may be also configured to receive the second indication from the first node 111. The second indication may be configured to request the stored information at the communications system 100 configured to indicate whether at least the first set of the one or more internet protocol addresses may be, respectively, configured to be dedicated to a respective single first application or shared by a respective first plurality of applications.

The second node 112 may be also configured to send the second indication to the third node 113 configured to operate in a communications system 100.

The second node 112 may be also configured to receive the stored information from the third node 113.

The second node 112 may be also configured to send the second information configured to indicate the stored information to the first node 111. The first information configured to be received from the first node 111 may be configured to be based on the second information configured to be sent.

In some embodiments, the first indication may be configured to comprise at least one of: a) the first identifier of the analytic configured to indicate request of the first information, b) the second identifier of the one or more devices 130 for which the first information may be configured to be requested, c) the third identifier of the one or more applications for which the first information may be configured to be requested, and d) the one or more filters to be applied to the first information to be provided in response to the first indication.

In some embodiments, the one or more operations may be configured to comprise at least to: send the sixth indication to the third node 113 configured to operate in the communications system 100. The sixth indication may be configured to request the update of the stored data with the first information configured to be received.

In some embodiments, at least one of the following may apply: a) the communications system 100 may be configured to be a 5G system, b) the first node 111 may be configured to be a NWDAF, c) the second node 112 may be configured to be a NEF, d) the third node 113 may be configured to be a UDR, e) the second information configured to be sent to the first node 111 may be configured to be derived from PFDs, and f) the stored information may be configured to comprise the list of identifiers of applications and PFDs of Type Server IP.

The embodiments herein in the second node 112 may be implemented through one or more processors, such as a processing circuitry 1001 in the second node 112 depicted in FIG. 10, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1002 comprising one or more memory units. The memory 1002 is arranged to be used to store obtained information, store data, configurations, schedulings, and applications etc. to perform the methods herein when being executed in the second node 112.

In some embodiments, the second node 112 may receive information from, e.g., the first node 111, the third node 113, the fourth node 114, the fifth node 115, the sixth node 116, the seventh node 117, the one or more nodes 113, 114, 115, the radio network node 140, the one or more devices 130, another node, and/or another structure in the communications system 100, through a receiving port 1003. In some embodiments, the receiving port 1003 may be, for example, connected to one or more antennas in second node 112. In other embodiments, the second node 112 may receive information from another structure in the communications system 100 through the receiving port 1003. Since the receiving port 1003 may be in communication with the processing circuitry 1001, the receiving port 1003 may then send the received information to the processing circuitry 1001. The receiving port 1003 may also be configured to receive other information.

The processing circuitry 1001 in the second node 112 may be further configured to transmit or send information to e.g., the first node 111, the third node 113, the fourth node 114, the fifth node 115, the sixth node 116, the seventh node 117, the one or more nodes 113, 114, 115, the radio network node 140, the one or more devices 130, another node, and/or another structure in the communications system 100, through a sending port 1004, which may be in communication with the processing circuitry 1001, and the memory 1002.

Those skilled in the art will also appreciate that the units comprised within the second node 112 described above as being configured to perform different actions, may refer to a combination of analog and digital circuits, and/or one or more processors configured with software and/or firmware, e.g., stored in memory, that, when executed by the one or more processors such as the processing circuitry 1001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 112 described above as being configured to perform different actions described above may be implemented as one or more applications running on one or more processors such as the processing circuitry 1001.

Thus, the methods according to the embodiments described herein for the second node 112 may be respectively implemented by means of a computer program 1005 product, comprising instructions, i.e., software code portions, which, when executed on at least one processing circuitry 1001, cause the at least one processing circuitry 1001 to carry out the actions described herein, as performed by the second node 112. The computer program 1005 product may be stored on a computer-readable storage medium 1006. The computer-readable storage medium 1006, having stored thereon the computer program 1005, may comprise instructions which, when executed on at least one processing circuitry 1001, cause the at least one processing circuitry 1001 to carry out the actions described herein, as performed by the second node 112. In some embodiments, the computer-readable storage medium 1006 may be a non-transitory computer-readable storage medium, such as a CD ROM disc, or a memory stick. In other embodiments, the computer program 1005 product may be stored on a carrier containing the computer program 1005 just described, wherein the carrier is one of an electronic signal, optical signal, radio signal, or the computer-readable storage medium 1006, as described above.

The second node 112 may comprise a communication interface configured to facilitate, or an interface unit to facilitate, communications between the second node 112 and other nodes or devices, e.g., the first node 111, the third node 113, the fourth node 114, the fifth node 115, the sixth node 116, the seventh node 117, the one or more nodes 113, 114, 115, the radio network node 140, the one or more devices 130, another node, and/or another structure in the communications system 100. The interface may, for example, include a transceiver configured to transmit and receive radio signals over an air interface in accordance with a suitable standard.

In other embodiments, the second node 112 may comprise a radio circuitry 1007, which may comprise e.g., the receiving port 1003 and the sending port 1004.

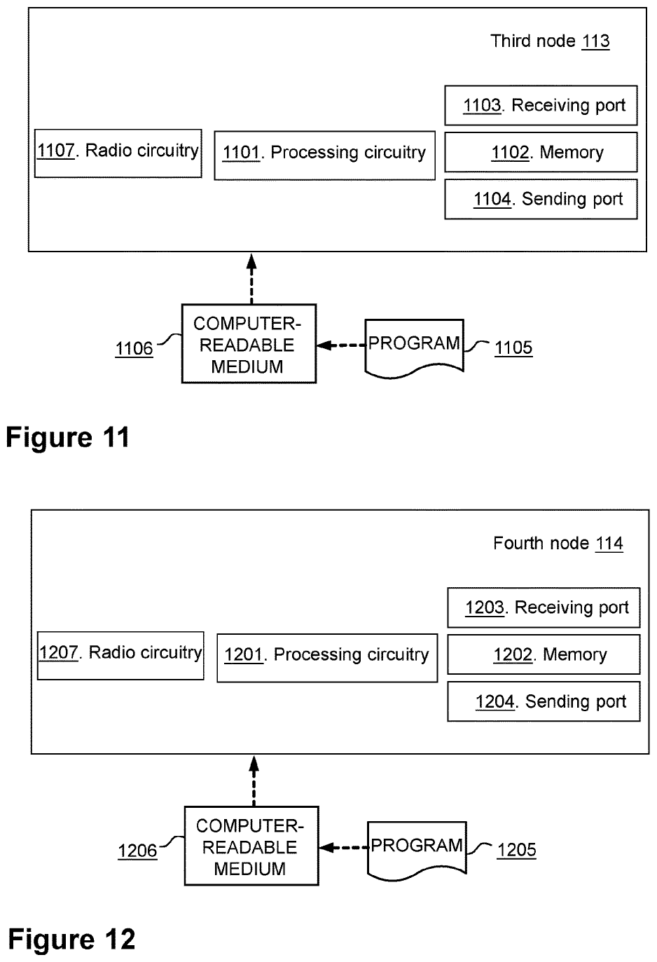

The radio circuitry 1007 may be configured to set up and maintain at least a wireless connection with the first node 111, the third node 113, the fourth node 114, the fifth node 115, the sixth node 116, the seventh node 117, the one or more nodes 113, 114, 115, the radio network node 140, the one or more devices 130, another node, and/or another structure in the communications system 100. Circuitry may be understood herein as a hardware component. Hence, embodiments herein also relate to the second node 112, operative to operate in the communications system 100. The second node 112 may comprise the processing circuitry 1001 and the memory 1002, said memory 1002 containing instructions executable by said processing circuitry 1001, whereby the second node 112 is further operative to perform the actions described herein in relation to the second node 112, e.g., in FIG. 4 and/or FIG. 8. FIG. 11 depicts an example of the arrangement that the third node 113 may comprise to perform the method described in FIG. 5 and/or FIG. 8. The third node 113 may be understood to be for handling the one or more internet protocol addresses. The third node 113 is configured to operate in the communications system 100.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, in some embodiments, the first node 111 may be configured to be an NWDAF.

The third node 113 is configured to receive the second indication from the first node 111 configured to operate in the communications system 100, directly or indirectly via the second node 112 configured to operate in the communications system 100. The second indication is configured to request the stored information at the communications system 100 configured to indicate whether at least the first set of the one or more internet protocol addresses are, respectively, configured to be dedicated to a respective single first application or shared by a respective first plurality of applications.

The third node 113 is also configured to send the stored information configured to be requested to the first node 111 directly or indirectly via the second node 112.

The third node 113 may be further configured to, after having sent the stored information configured to have been requested, initiate sending the third request for the service, for the session application, to at least one of the one or more third nodes 113 configured to be identified.

The third node 113 may be further configured to, after having sent the stored information configured to have been requested, receive the seventh indication from the fifth node 115 configured to operate in the communications system 100. The seventh indication may be configured to request whether the one or more internet protocol addresses in the fourth set of the one or more internet protocol addresses for which it may be unknown whether the one or more internet protocol addresses in the fourth set may be, respectively, configured to be dedicated to a respective application or shared by a respective plurality of applications, may be, respectively, configured to be dedicated to a respective single application or shared by a respective plurality of applications.

The third node 113 may be further configured to, after having sent the stored information configured to have been requested, send, responsive to receiving the seventh indication, the eighth indication to the fifth node 115. The eighth indication may be configured to indicate whether the one or more internet protocol addresses in the fourth set may be, respectively, configured to be dedicated to a respective single application or shared by a respective plurality of applications.

The third node 113 may be further configured to, after having sent the stored information configured to have been requested, receive the sixth indication from the second node 112.

The sixth indication may be configured to request the update of the stored data with the first information configured to indicate whether the one or more internet protocol addresses may be, respectively, configured to be dedicated to a respective single application, or shared by a respective plurality of applications.

The third node 113 may be further configured to, after having sent the stored information configured to have been requested, update, responsive to the sixth indication configured to be received, the stored data with the first information.

In some embodiments, at least one of the following may apply: a) the communications system 100 may be configured to be a 5G system, b) the first node 111 may be configured to be a NWDAF, c) the second node 112 may be configured to be a NEF, d) the third node 113 may be configured to be a UDR, e) the fifth node 115 may be configured to be a SAMF, and f) the stored information may be configured to comprise the list of identifiers of applications and PFDs of Type Server IP.

The embodiments herein in the third node 113 may be implemented through one or more processors, such as a processing circuitry 1101 in the third node 113 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1102 comprising one or more memory units. The memory 1102 is arranged to be used to store obtained information, store data, configurations, schedulings, and applications etc. to perform the methods herein when being executed in the third node 113.

In some embodiments, the third node 113 may receive information from, e.g., the first node 111, the second node 112, the fourth node 114, the fifth node 115, the sixth node 116, the seventh node 117, the one or more nodes 114, 115, the radio network node 140, the one or more devices 130, another node, and/or another structure in the communications system 100, through a receiving port 1103. In some embodiments, the receiving port 1103 may be, for example, connected to one or more antennas in third node 113. In other embodiments, the third node 113 may receive information from another structure in the communications system 100 through the receiving port 1103. Since the receiving port 1103 may be in communication with the processing circuitry 1101, the receiving port 1103 may then send the received information to the processing circuitry 1101. The receiving port 1103 may also be configured to receive other information.

The processing circuitry 1101 in the third node 113 may be further configured to transmit or send information to e.g., the first node 111, the second node 112, the fourth node 114, the fifth node 115, the sixth node 116, the seventh node 117, the one or more nodes 114, 115, the radio network node 140, the one or more devices 130, another node, and/or another structure in the communications system 100, through a sending port 1104, which may be in communication with the processing circuitry 1101, and the memory 1102.

Those skilled in the art will also appreciate that the units comprised within the third node 113 described above as being configured to perform different actions, may refer to a combination of analog and digital circuits, and/or one or more processors configured with software and/or firmware, e.g., stored in memory, that, when executed by the one or more processors such as the processing circuitry 1101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the third node 113 described above as being configured to perform different actions described above may be implemented as one or more applications running on one or more processors such as the processing circuitry 1101.

Thus, the methods according to the embodiments described herein for the third node 113 may be respectively implemented by means of a computer program 1105 product, comprising instructions, i.e., software code portions, which, when executed on at least one processing circuitry 1101, cause the at least one processing circuitry 1101 to carry out the actions described herein, as performed by the third node 113. The computer program 1105 product may be stored on a computer-readable storage medium 1106. The computer-readable storage medium 1106, having stored thereon the computer program 1105, may comprise instructions which, when executed on at least one processing circuitry 1101, cause the at least one processing circuitry 1101 to carry out the actions described herein, as performed by the third node 113. In some embodiments, the computer-readable storage medium 1106 may be a non-transitory computer-readable storage medium, such as a CD ROM disc, or a memory stick. In other embodiments, the computer program 1105 product may be stored on a carrier containing the computer program 1105 just described, wherein the carrier is one of an electronic signal, optical signal, radio signal, or the computer-readable storage medium 1106, as described above.

The third node 113 may comprise a communication interface configured to facilitate, or an interface unit to facilitate, communications between the third node 113 and other nodes or devices, e.g., the first node 111, the second node 112, the fourth node 114, the fifth node 115, the sixth node 116, the seventh node 117, the one or more nodes 114, 115, the radio network node 140, the one or more devices 130, another node, and/or another structure in the communications system 100. The interface may, for example, include a transceiver configured to transmit and receive radio signals over an air interface in accordance with a suitable standard.

In other embodiments, the third node 113 may comprise a radio circuitry 1107, which may comprise e.g., the receiving port 1103 and the sending port 1104.

The radio circuitry 1107 may be configured to set up and maintain at least a wireless connection with the first node 111, the second node 112, the fourth node 114, the fifth node 115, the sixth node 116, the seventh node 117, the one or more nodes 114, 115, the radio network node 140, the one or more devices 130, another node, and/or another structure in the communications system 100. Circuitry may be understood herein as a hardware component. Hence, embodiments herein also relate to the third node 113, operative to operate in the communications system 100. The third node 113 may comprise the processing circuitry 1101 and the memory 1102, said memory 1102 containing instructions executable by said processing circuitry 1101, whereby the third node 113 is further operative to perform the actions described herein in relation to the third node 113, e.g., in FIG. 5 and/or FIG. 8.

FIG. 12 depicts an example of the arrangement that the fourth node 114 may comprise to perform the method described in FIG. 6 and/or FIG. 8. The fourth node 114 may be understood to be for handling the one or more internet protocol addresses. The fourth node 114 is configured to operate in the communications system 100.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the fourth node 114 and will thus not be repeated here. For example, in some embodiments, the third indication may be configured to be received indirectly from the first node 111, via the seventh node 117.

The fourth node 114 is configured to receive, directly or indirectly, the third indication from the first node 111 configured to operate in the communications system 100. The third indication is configured to request the notification of the one or more events to occur in the communications system 100 based on the application traffic. The one or more events are configured to indicate whether at least the second set of the one or more internet protocol addresses are, respectively, configured to be dedicated to a respective single second application or shared by a respective second plurality of applications.

The fourth node 114 is also configured to send the notification configured to be requested to the first node 111.

The fourth node 114 may be further configured to apply the packet detection rule procedure to traffic configured to be detected based on the third indication configured to be received. The requested notification configured to be sent may be configured to be based on the packet detection rule procedure configured to be applied.

In some embodiments at least one of the following may apply: a) the communications system 100 may be configured to be a 5G system, b) the first node 111 may be configured to be a NWDAF, and c) the fourth node 114 may be configured to be a UPF.

The embodiments herein in the fourth node 114 may be implemented through one or more processors, such as a processing circuitry 1201 in the fourth node 114 depicted in FIG. 12, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the fourth node 114. One such carrier may be in the form of a CD ROM disc. It is however feasible with other data carriers such as a memory stick. The computer program code may furthermore be provided as pure program code on a server and downloaded to the fourth node 114.

The fourth node 114 may further comprise a memory 1202 comprising one or more memory units. The memory 1202 is arranged to be used to store obtained information, store data, configurations, schedulings, and applications etc. to perform the methods herein when being executed in the fourth node 114.

In some embodiments, the fourth node 114 may receive information from, e.g., the first node 111, the second node 112, the third node 113, the fifth node 115, the sixth node 116, the seventh node 117, the one or more nodes 113, 115, the radio network node 140, the one or more devices 130, another node, and/or another structure in the communications system 100, through a receiving port 1203. In some embodiments, the receiving port 1203 may be, for example, connected to one or more antennas in fourth node 114. In other embodiments, the fourth node 114 may receive information from another structure in the communications system 100 through the receiving port 1203. Since the receiving port 1203 may be in communication with the processing circuitry 1201, the receiving port 1203 may then send the received information to the processing circuitry 1201. The receiving port 1203 may also be configured to receive other information.

The processing circuitry 1201 in the fourth node 114 may be further configured to transmit or send information to e.g., the first node 111, the second node 112, the third node 113, the fifth node 115, the sixth node 116, the seventh node 117, the one or more nodes 113, 115, the radio network node 140, the one or more devices 130, another node, and/or another structure in the communications system 100, through a sending port 1204, which may be in communication with the processing circuitry 1201, and the memory 1202.

Those skilled in the art will also appreciate that the units comprised within the fourth node 114 described above as being configured to perform different actions, may refer to a combination of analog and digital circuits, and/or one or more processors configured with software and/or firmware, e.g., stored in memory, that, when executed by the one or more processors such as the processing circuitry 1201, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the fourth node 114 described above as being configured to perform different actions described above may be implemented as one or more applications running on one or more processors such as the processing circuitry 1201.

Thus, the methods according to the embodiments described herein for the fourth node 114 may be respectively implemented by means of a computer program 1205 product, comprising instructions, i.e., software code portions, which, when executed on at least one processing circuitry 1201, cause the at least one processing circuitry 1201 to carry out the actions described herein, as performed by the fourth node 114. The computer program 1205 product may be stored on a computer-readable storage medium 1206. The computer-readable storage medium 1206, having stored thereon the computer program 1205, may comprise instructions which, when executed on at least one processing circuitry 1201, cause the at least one processing circuitry 1201 to carry out the actions described herein, as performed by the fourth node 114. In some embodiments, the computer-readable storage medium 1206 may be a non-transitory computer-readable storage medium, such as a CD ROM disc, or a memory stick. In other embodiments, the computer program 1205 product may be stored on a carrier containing the computer program 1205 just described, wherein the carrier is one of an electronic signal, optical signal, radio signal, or the computer-readable storage medium 1206, as described above.

The fourth node 114 may comprise a communication interface configured to facilitate, or an interface unit to facilitate, communications between the fourth node 114 and other nodes or devices, e.g., the first node 111, the second node 112, the third node 113, the fifth node 115, the sixth node 116, the seventh node 117, the one or more nodes 113, 115, the radio network node 140, the one or more devices 130, another node, and/or another structure in the communications system 100. The interface may, for example, include a transceiver configured to transmit and receive radio signals over an air interface in accordance with a suitable standard.

In other embodiments, the fourth node 114 may comprise a radio circuitry 1207, which may comprise e.g., the receiving port 1203 and the sending port 1204.

The radio circuitry 1207 may be configured to set up and maintain at least a wireless connection with the first node 111, the second node 112, the third node 113, the fifth node 115, the sixth node 116, the seventh node 117, the one or more nodes 113, 115, the radio network node 140, the one or more devices 130, another node, and/or another structure in the communications system 100. Circuitry may be understood herein as a hardware component. Hence, embodiments herein also relate to the fourth node 114, operative to operate in the communications system 100. The fourth node 114 may comprise the processing circuitry 1201 and the memory 1202, said memory 1202 containing instructions executable by said processing circuitry 1201, whereby the fourth node 114 is further operative to perform the actions described herein in relation to the fourth node 114, e.g., in FIG. 6 and/or FIG. 8.

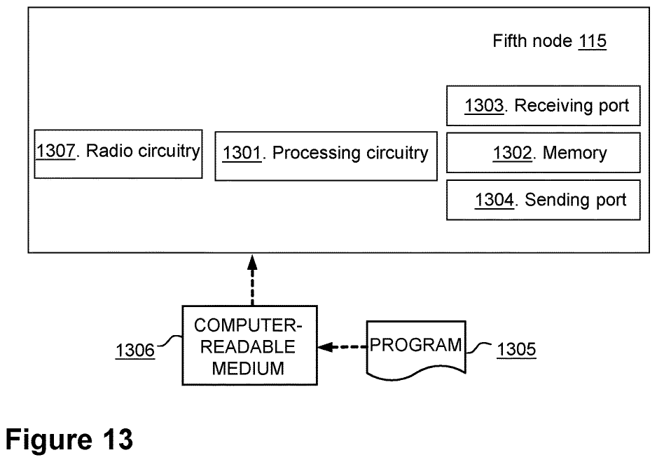

FIG. 13 depicts an example of the arrangement that the fifth node 115 may comprise to perform the method described in FIG. 7 and/or FIG. 8. The fifth node 115 may be understood to be for handling the one or more internet protocol addresses. The fifth node 115 is configured to operate in the communications system 100.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the fifth node 115 and will thus not be repeated here. For example, in some examples, the fifth node 115 may be a SAMF.

The fifth node 115 is configured to receive the fourth indication from the first node 111 configured to operate in the communications system 100. The fourth indication may be configured to request whether the one or more internet protocol addresses in the fourth set of the one or more internet protocol addresses for which it is unknown whether the one or more internet protocol addresses in the fourth set are, respectively, configured to be dedicated to a respective application or shared by a respective plurality of applications are, respectively, configured to be dedicated to a respective single application or shared by a respective plurality of applications.

The fifth node 115 is also configured to send, responsive to the fourth indication configured to be received, the fifth indication to the first node 111. The fifth indication is configured to indicate whether the one or more internet protocol addresses in the fourth set are, respectively, configured to be dedicated to a respective single application or shared by a respective plurality of applications.

The fifth node 115 may be further configured to send, responsive to the fourth indication configured to be received, the respective first TLS message to at least the first subset of the one or more internet protocol addresses in the fourth set. The respective first TLS message may be configured to be a client Hello message excluding the server name indication.

The fifth node 115 may be further configured to receive, in response to the respective first TLS message configured to be sent, at least one respective second TLS message from at least one of the one or more internet protocol addresses in the first subset of the fourth set.

The respective second TLS message may be configured to comprise the respective certificate of the respective server 116 configured to be associated with the respective one or more internet protocol addresses in the fourth set. The fifth indication may be configured to be based on the respective certificate.

The fifth node 115 may be further configured to determine, based on the respective certificate configured to be received, whether at least one of the one or more internet protocol addresses in the fourth set may be, respectively, configured to be dedicated to a respective single application or shared by a respective plurality of applications. The fifth indication may be based on the result of the determination.

In some embodiments, the fifth node 115 may be further configured to send, responsive to the fourth indication configured to be received and prior to sending the respective first TLS message, the seventh indication to the third node 113 configured to operate in the communications system 100. The seventh indication may be configured to request whether the one or more internet protocol addresses in the fourth set may be, respectively, dedicated to a respective single application or shared by a respective plurality of applications.

In some embodiments, the fifth node 115 may be further configured to receive, responsive to the sent seventh indication, the eighth indication from the third node 113. The eighth indication may be configured to indicate whether the one or more internet protocol addresses in the fourth set may be, respectively, configured to be dedicated to a respective single application or shared by a respective plurality of applications. The respective first message may be configured to be sent based on the eighth indication configured to be received.

In some embodiments, at least one of the following may apply: a) the communications system 100 may be configured to be a Fifth Generation, 5G, system, b) the first node 111 may be configured to be a NWDAF, c) third node 113 may be configured to be a UDR, d) the fifth node 115 may be configured to be a SAMF.

The embodiments herein in the fifth node 115 may be implemented through one or more processors, such as a processing circuitry 1301 in the fifth node 115 depicted in FIG. 13, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the fifth node 115. One such carrier may be in the form of a CD ROM disc. It is however feasible with other data carriers such as a memory stick. The computer program code may furthermore be provided as pure program code on a server and downloaded to the fifth node 115.

The fifth node 115 may further comprise a memory 1302 comprising one or more memory units. The memory 1302 is arranged to be used to store obtained information, store data, configurations, schedulings, and applications etc. to perform the methods herein when being executed in the fifth node 115.

In some embodiments, the fifth node 115 may receive information from, e.g., the first node 111, the second node 112, the third node 113, the fourth node 114, the sixth node 116, the seventh node 117, the one or more nodes 113, 114, the radio network node 140, the one or more devices 130, another node, and/or another structure in the communications system 100, through a receiving port 1303. In some embodiments, the receiving port 1303 may be, for example, connected to one or more antennas in fifth node 115. In other embodiments, the fifth node 115 may receive information from another structure in the communications system 100 through the receiving port 1303. Since the receiving port 1303 may be in communication with the processing circuitry 1301, the receiving port 1303 may then send the received information to the processing circuitry 1301. The receiving port 1303 may also be configured to receive other information.

The processing circuitry 1301 in the fifth node 115 may be further configured to transmit or send information to e.g., the first node 111, the second node 112, the third node 113, the fourth node 114, the sixth node 116, the seventh node 117, the one or more nodes 113, 114, the radio network node 140, the one or more devices 130, another node, and/or another structure in the communications system 100, through a sending port 1304, which may be in communication with the processing circuitry 1301, and the memory 1302.

Those skilled in the art will also appreciate that the units comprised within the fifth node 115 described above as being configured to perform different actions, may refer to a combination of analog and digital circuits, and/or one or more processors configured with software and/or firmware, e.g., stored in memory, that, when executed by the one or more processors such as the processing circuitry 1301, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the fifth node 115 described above as being configured to perform different actions described above may be implemented as one or more applications running on one or more processors such as the processing circuitry 1301.

Thus, the methods according to the embodiments described herein for the fifth node 115 may be respectively implemented by means of a computer program 1305 product, comprising instructions, i.e., software code portions, which, when executed on at least one processing circuitry 1301, cause the at least one processing circuitry 1301 to carry out the actions described herein, as performed by the fifth node 115. The computer program 1305 product may be stored on a computer-readable storage medium 1306. The computer-readable storage medium 1306, having stored thereon the computer program 1305, may comprise instructions which, when executed on at least one processing circuitry 1301, cause the at least one processing circuitry 1301 to carry out the actions described herein, as performed by the fifth node 115. In some embodiments, the computer-readable storage medium 1306 may be a non-transitory computer-readable storage medium, such as a CD ROM disc, or a memory stick. In other embodiments, the computer program 1305 product may be stored on a carrier containing the computer program 1305 just described, wherein the carrier is one of an electronic signal, optical signal, radio signal, or the computer-readable storage medium 1306, as described above.

The fifth node 115 may comprise a communication interface configured to facilitate, or an interface unit to facilitate, communications between the fifth node 115 and other nodes or devices, e.g., the first node 111, the second node 112, the third node 113, the fourth node 114, the sixth node 116, the seventh node 117, the one or more nodes 113, 114, the radio network node 140, the one or more devices 130, another node, and/or another structure in the communications system 100. The interface may, for example, include a transceiver configured to transmit and receive radio signals over an air interface in accordance with a suitable standard.

In other embodiments, the fifth node 115 may comprise a radio circuitry 1307, which may comprise e.g., the receiving port 1303 and the sending port 1304.

The radio circuitry 1307 may be configured to set up and maintain at least a wireless connection with the first node 111, the second node 112, the third node 113, the fourth node 114, the sixth node 116, the seventh node 117, the one or more nodes 113, 114, the radio network node 140, the one or more devices 130, another node, and/or another structure in the communications system 100. Circuitry may be understood herein as a hardware component. Hence, embodiments herein also relate to the fifth node 115, operative to operate in the communications system 100. The fifth node 115 may comprise the processing circuitry 1301 and the memory 1302, said memory 1302 containing instructions executable by said processing circuitry 1301, whereby the fifth node 115 is further operative to perform the actions described herein in relation to the fifth node 115, e.g., in FIG. 7 and/or FIG. 8.

Embodiments herein may also comprise the communications system 100 comprising one or more of: the first node 111 configured as described in relation to FIG. 9, the second node 112 configured as described in relation to FIG. 10, the third node 113 configured as described in relation to FIG. 11, the fourth node 114 configured as described in relation to FIG. 12 and the fifth node 115 configured as described in relation to FIG. 13.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise.

The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. 3GPP TS 23.288 v. 18.2.0 (June 2023): Architecture enhancements for 5G System (5GS) to support network data analytics services.

1. A computer-implemented method, performed by a first node, for handling one or more internet protocol addresses, the first node operating in a communications system, the method comprising:
determining first information indicating whether the one or more internet protocol addresses are, respectively, dedicated to a respective single application, or shared by a respective plurality of applications; and
providing the determined first information to a second node operating in the communications system.

2. The method according to claim 1, further comprising at least one of:
obtaining a first indication, directly or indirectly, from the second node, the first indication requesting the first information, and wherein the determining is performed in response to the obtained first indication; and
initiating collecting second information indicating the first information from one or more other nodes operating in the communications system, and wherein the determining of the first information is based on the second information collected from the one or more other nodes.

3. The method according to claim 2, wherein the first indication comprises at least one of:
a first identifier of an analytic indicating request of the first information;
a second identifier of one or more devices for which the first information is requested;
a third identifier of one or more applications for which the first information is requested; and
one or more filters to be applied to the first information to be provided in response to the first indication.

4. The method according to claim 2, wherein the initiating of the collection of the second information comprises, at least one of:
sending, directly or indirectly, a second indication to a third node operating in the communications system the second indication requesting stored information at the communications system indicating whether at least a first set of the one or more internet protocol addresses are, respectively, dedicated to a respective single first application or shared by a respective first plurality of applications; and
sending, directly or indirectly, a third indication to a fourth node operating in the communications system, the third indication requesting notification of one or more events to occur in the communications system based on application traffic, the one or more events indicating whether at least a second set of the one or more internet protocol addresses are, respectively, dedicated to a respective single second application or shared by a respective second plurality of applications.

5. The method according to claim 4, further comprising:
determining based on at least one of: the stored information and the notification of the one or more events, out of the first set of the one or more internet protocol addresses and the second set of the one or more internet protocol addresses:
a third set of the one or more internet protocol addresses for which it is known whether the one or more internet protocol addresses in the third set are, respectively, dedicated to a respective single application or shared by a respective plurality of applications; and
a fourth set of the one or more internet protocol addresses for which it is unknown whether the one or more internet protocol addresses in the fourth set are, respectively, dedicated to a respective application or shared by a respective plurality of applications;
sending a fourth indication to a fifth node operating in the communications system the fourth indication requesting whether the one or more internet protocol addresses in the fourth set are, respectively, dedicated to a respective single application or shared by a respective plurality of applications ; and
receiving, responsive to the sent fourth indication, a fifth indication from the fifth node the fifth indication indicating whether the one or more internet protocol addresses in the fourth set are, respectively, dedicated to a respective single application or shared by a respective plurality of applications, and wherein the determining of the first information is based on the received fifth indication.

6. The method according to claim 2, wherein at least one of:
the communications system is a Fifth Generation, 5G, system;
the first node is a Network Data Analytics Function, NWDAF;
the second node is a Network Exposure Function, NEF;
the one or more other nodes comprise at least one of:
a third node, the third node being a User Data Repository, UDR;
a fourth node, the fourth node being a User Plane Function, UPF; and
a fifth node, the fifth node being a Server to Application Mapping Function, SAMF;
the second information collected by the first node is derived from Packet Flow Descriptions, PFDs; and
the second information collected by the first node comprises a list of identifiers of applications and PFDs of Type Server IP received by the first node from the third node via the second node

7. A computer-implemented method, performed by a second node, for handling one or more internet protocol addresses, the second node operating in a communications system, the method comprising:
receiving first information from a first node operating in the communications system, the first information indicating whether the one or more internet protocol addresses are, respectively, dedicated to a respective single application, or shared by a respective plurality of applications.

8. The method according to claim 7, further comprising at least one of:
sending a first indication requesting the first information, directly or indirectly, to the first node, and wherein the first information is received responsive to the sent first indication;
initiating one or more operations in the communications system based on the received first information;
receiving a second indication from the first node, the second indication requesting stored information at the communications system indicating whether at least a first set of the one or more internet protocol addresses are, respectively, dedicated to a respective single first application or shared by a respective first plurality of applications;
sending the second indication to a third node operating in a communications system;
receiving the stored information from the third node; and
sending second information indicating the stored information to the first node, and wherein the first information received from the first node is based on the sent second information.

9. The method according to claim 8, wherein the first indication comprises at least one of:
a first identifier of an analytic indicating request of the first information;
a second identifier of one or more devices for which the first information is requested;
a third identifier of one or more applications for which the first information is requested; and
one or more filters to be applied to the first information to be provided in response to the first indication.

10. The method according to claim 8, wherein the one or more operations comprise at least:
sending a sixth indication to a third node operating in the communications system the sixth indication requesting an update of stored data with the received first information.

11. The method according to claim 10, wherein at least one of:
the communications system is a Fifth Generation, 5G, system;
the first node is a Network Data Analytics Function, NWDAF;
the second node is a Network Exposure Function, NEF;
the third node is a User Data Repository, UDR;
the second information sent to the first node is derived from Packet Flow Descriptions, PFDs; and
the stored information comprises a list of identifiers of applications and PFDs of Type Server IP.

12.-21. (canceled)

22. A first node, for handling one or more internet protocol addresses, the first node being configured to operate in a communications system, the first node further configured to:
determine first information configured to indicate whether the one or more internet protocol addresses are, respectively, configured to be dedicated to a respective single application, or shared by a respective plurality of applications; and
providing the determined first information to a second node configured to operate in the communications system.

23. The first node according to claim 22, further configured to at least one of:
obtain a first indication, directly or indirectly, from the second node, the first indication being configured to request the first information, and wherein the determining is configured to be performed in response to the first indication configured to be obtained; and
initiate collecting second information configured to indicate the first information from one or more other nodes operating in the communications system, and wherein the determining of the first information is configured to be based on the second information configured to be collected from the one or more other nodes.

24. The first node according to claim 23, wherein the first indication is configured to comprise at least one of:
a first identifier of an analytic configured to indicate request of the first information,
a second identifier of one or more devices for which the first information is configured to be requested;
a third identifier of one or more applications for which the first information is configured to be requested; and
one or more filters to be applied to the first information configured to be to be provided in response to the first indication.

25. The first node according to claim 23, wherein the initiating of the collection of the second information is configured to comprise to, at least one of:
send, directly or indirectly, a second indication to a third node configured to operate in the communications system, the second indication being configured to request stored information at the communications system configured to indicate whether at least a first set of the one or more internet protocol addresses are, respectively, configured to be dedicated to a respective single first application or shared by a respective first plurality of applications; and
send, directly or indirectly, a third indication to a fourth node configured to operate in the communications system, the third indication being configured to request notification of one or more events to occur in the communications system based on application traffic, the one or more events being configured to indicate whether at least a second set of the one or more internet protocol addresses are, respectively, configured to be dedicated to a respective single second application or shared by a respective second plurality of applications.

26. The first node according to claim 25, further configured to:
determine, based on at least one of: the stored information and the notification of the one or more events, out of the first set of the one or more internet protocol addresses and the second set of the one or more internet protocol addresses:
a third set of the one or more internet protocol addresses for which it is known whether the one or more internet protocol addresses in the third set are, respectively, configured to be dedicated to a respective single application or shared by a respective plurality of applications; and
a fourth set of the one or more internet protocol addresses for which it is unknown whether the one or more internet protocol addresses in the fourth set are, respectively, configured to be dedicated to a respective application or shared by a respective plurality of applications;
send a fourth indication to a fifth node configured to operate in the communications system, the fourth indication being configured to request whether the one or more internet protocol addresses in the fourth set are, respectively, configured to be dedicated to a respective single application or shared by a respective plurality of applications; and
receive, responsive to the fourth indication configured to be sent, a fifth indication from the fifth node, the fifth indication being configured to indicate whether the one or more internet protocol addresses in the fourth set are, respectively, configured to be dedicated to a respective single application or shared by a respective plurality of applications, and wherein the determining of the first information is configured to be based on the fifth indication configured to be received.

27. The first node according to claim 2, wherein at least one of:
the communications system is configured to be a Fifth Generation, 5G, system;
the first node is configured to be a Network Data Analytics Function, NWDAF;
the second node is configured to be a Network Exposure Function, NEF;
the one or more other nodes are configured to comprise at least one of:
a third node the third node being a User Data Repository, UDR;
a fourth node the fourth node being configured to be a User Plane Function, UPF; and
a fifth node the fifth node being configured to be a Server to Application Mapping Function, SAMF;
the second information configured to be collected by the first node is configured to be derived from Packet Flow Descriptions, PFDs; and
the second information configured to be collected by the first node is configured to comprise a list of identifiers of applications and PFDs of Type Server IP configured to be received by the first node from the third node via the second node

28. A second node, for handling one or more internet protocol addresses, the second node being configured to operate in a communications system, the second node further configured to:
receive first information from a first node configured to operate in the communications system, the first information being configured to indicate whether the one or more internet protocol addresses are, respectively, configured to be dedicated to a respective single application, or shared by a respective plurality of applications.

29. The second node according to claim 28, further configured to at least one of:
send a first indication configured to request the first information, directly or indirectly, to the first node, and wherein the first information is configured to be received responsive to the first indication configured to be sent;
initiate one or more operations in the communications system based on the first information configured to be received;
receive a second indication from the first node the second indication being configured to request stored information at the communications system configured to indicate whether at least a first set of the one or more internet protocol addresses are, respectively, configured to be dedicated to a respective single first application or shared by a respective first plurality of applications;
send the second indication to a third node configured to operate in a communications system;
receive the stored information from the third node; and
send second information configured to indicate the stored information to the first node, and wherein the first information configured to be received from the first node is configured to be based on the second information configured to be sent.

30. The second node according to claim 29, wherein the first indication is configured to comprise at least one of:
a first identifier of an analytic configured to indicate request of the first information;
a second identifier of one or more devices for which the first information is configured to be requested;
a third identifier of one or more applications for which the first information is configured to be requested; and
one or more filters to be applied to the first information to be provided in response to the first indication.

31.-42. (canceled)
